(19) United States
(12) Patent Application Publication
(10) Pub. No.: US 2002/0025832 A1
(43) Pub. Date: Feb. 28, 2002

(54) Controlling data transmission involving a wireless telephone

(76) Inventors: Michael B. Durian, Boulder, CO (US); Ralph C. Poplawsky, Littleton, CO (US)

Correspondence Address: Bradley M. Knepper, SHERIDAN ROSS P.C., Suite 1200, 1560 Broadway, Denver, CO, 80202-5141, US

(21) Appl. No.: 09/866,308

(22) Filed: May 24, 2001

Related U.S. Application Data
(63) Continuation-in-part of application No. 09/507,175, filed on Feb. 18, 2000.

(51) Int. Cl. H04M 1/00; H04B 1/38

(52) U.S. Cl. 455/556; 455/557; 455/575; 455/90

(57) ABSTRACT

Wireless communications relative to a vehicle using a wireless communications device, a an adaptor for holding the wireless communications device and a docking station in communication with the adaptor are provided. An external subsystem running an application can be interconnected to the wireless communications device via the adaptor and the docking station. In particular, the docking station provides a standardized interface that can be used to conduct communications between the external device and the docking station. In addition, the docking station can receive commands from the external subsystem regarding a communication channel established between the wireless communications device and a base station or server. These commands may be formatted according to a standardized protocol. Translation of the commands from the standardized protocol to the command protocol required to operate the wireless communications device is performed in the docking station and the adaptor. The system allows applications running on external subsystems to transmit and receive data established by the wireless communications device using a standardized physical interface and command set. In this way, the particular commands and physical interface required to operate a wireless communications device do not need to be accommodated by the external subsystems.

The present application is a continuation in part of, and claims priority in, U.S. patent application Ser. No. 09/507,175 filed Feb. 18, 2000, the entire disclosure of which is incorporated by reference herein.

### FIELD OF THE INVENTION

The present invention relates to wireless communications systems. In particular, the present invention relates to a method and apparatus for providing a wireless communications channel to devices or applications located in a vehicle through any communication device capable of wireless communications.

### BACKGROUND OF THE INVENTION

Wireless telephones, including cellular telephones, have become increasingly popular as a means for persons to remain in telephone, data and messaging contact with others, even when away from their home or office. In particular, wireless telephones allow persons traveling in vehicles to place and receive telephone calls, data and messages even while moving at high rates of speed. As wireless telephone technology has advanced, the telephones themselves have become smaller and smaller and more feature rich. In addition, and in particular with the implementation of various digital technologies, the stand-by and talk times provided by battery operated telephones have increased. The decrease in telephone size, the increase in features and the improvements in the battery life of wireless telephones have made the battery-operated wireless telephone an increasingly common communication device.

However, the small size and battery operated configuration of many wireless telephones can be disadvantageous when such telephones are used in automobiles. In particular, the small size of such telephones can make dialing and other operations difficult. In addition, even with advanced battery compositions and power-saving strategies, the batteries of wireless telephones eventually need to be recharged. Furthermore, when used to transmit data, a wireless telephone can typically be operatively connected to only one device or application at a time.

In order to address some of the disadvantages associated with the use of portable wireless telephones in vehicles, various “car kits” are known. At a most basic level, these car kits provide an interconnection between the telephone and the electrical system of the vehicle. These simple systems therefore allow the telephone to be powered by the electrical system of the car, and also to charge the telephone's battery. Other “car kits” provide a cradle fixed to the interior of the vehicle for holding the telephone, and require that the telephone be lifted from the cradle for use. Other simple “car kits” combine the interconnection to the vehicle's electrical system and the cradle for holding the telephone in a single device. However, these basic systems require that the user of the telephone remove at least one hand from the vehicle's controls in order to operate the telephone, and that the user hold the telephone to his or her face during calls.

At a next level, some conventional “car kits” provide basic speaker phone functions. These systems provide a microphone and speaker, external to the telephone, and adapted for use at a distance from the user. Therefore, with such a system, a telephone call could be conducted without requiring that the telephone be held to the face of the user. In order to provide a speaker phone capability, the device must generally interface with proprietary electrical contacts provided on the exterior of the telephone. Generally, telephone manufacturers provide electrical contacts for supplying power and for the input and output of audio signals on the exterior of the telephone. Additionally, various contacts for access to and the provision of telephone control signals may also be provided. Through these contacts, it is possible to control various functions of the telephone.

However, adaptors for physically securing the telephone to the interior of the automobile, and for electrically interconnecting the telephone to the automobile and to processors for providing desired functionalities can be expensive. In particular, the cost of providing a hands-free control system in a vehicle to accommodate a number of different wireless telephones can be cost prohibitive because the physical and electrical characteristics of telephones vary by manufacturer and by model.

In addition, conventional adaptors do not provide a way to connect multiple devices or applications to a wireless telephone such that the devices or applications may transfer data over a communications channel established by the wireless telephone. Furthermore, conventional adaptors do not allow for the simultaneous use of a communications channel established using a wireless telephone. In addition, conventional adaptors do not provide a common interface that can be used to physically attach devices or applications to a variety of wireless telephones having different interfaces. In particular, existing adaptors do not provide a control interface that allows a device to control aspects of the operation of a wireless telephone using a standardized interface.

In order to enable wireless communications devices to be used in connection with the transmission of data, a device must typically connect to a proprietary interface provided on the wireless telephone. Alternatively or in addition, the device or application interconnected to the telephone must be able to control the telephone to establish the required wireless connection. Often, the commands required to operate the telephone are unique to the particular telephone or brand of telephone to which the device or application is interconnected. Although standards concerning the commands that may be used to direct a telephone to establish a data link have been established, those standards have not been adopted by all telephone manufacturers. Therefore, a device must have the proper physical connector required to interface with the telephone, and the device or application running on the device must be able to communicate using the protocol and the command set required by the wireless telephone (i.e. using the communication interface of the telephone).

For the above-stated reasons, it would be advantageous to provide an improved method and apparatus for providing a hands-free wireless communications device in a vehicle. In addition, it would be advantageous to provide a method and an apparatus that allow for a single docking station containing many of the components necessary to provide the desired functions that can be used with any of a plurality of pocket devices provided for interfacing with supported telephones. Furthermore, it would be advantageous to provide a method and an apparatus that allows multiple devices or applications to interconnect to a wireless communications device and to communicate over a channel established by the wireless communications device at substantially the same time. It would also be advantageous to provide a method and an apparatus that allow a device to interconnect to a wireless telephone using a common interface, and to control the establishment of a communications channel using a standardized command set and protocol, without requiring the device to know how to control a particular wireless communications device. In addition, it would be advantageous to provide such a method and apparatus that can be implemented at an acceptable cost, that allow the user to easily and economically expand the provided functions, and that are reliable in operation.

### SUMMARY OF THE INVENTION

In accordance with the present invention, a system for allowing devices and applications to communicate over a channel established by a wireless communications device is provided. The disclosed system generally includes a docking station, a pocket or adaptor and a wireless communications device. In general, the pocket is adapted to interface a particular wireless communications device or family of devices to a common docking station that may be capable of functioning with different pocket designs. The pocket and the docking station interact with the wireless communications device to economically provide for the interconnection of devices or applications to the wireless communications device using a standardized interface.

A pocket in accordance with the present invention is adapted to be mechanically and electrically interconnected to a particular communications device or set of devices. Mechanical features of the pocket include surface features to allow the communications device to be held by the pocket and electrical connectors for mating with various electrical connectors provided with the communications device. Provisions for the electrical interconnection of the pocket and the communications device include, in addition to the above-mentioned electrical connectors, signal lines and processing capabilities. Accordingly, the pocket may provide for the passage of, e.g., radio frequency signals and digital data signals through the pocket without processing by the pocket. In addition, the pocket may include a processor for converting telephone control and other signals between the proprietary interface of the communications device and the application programming interface (API) of the system, allowing the pocket to pass telephone control and other information between the pocket processor and the docking station using a pocket docking station communications bus. Because the physical and electrical characteristics of communications devices such as wireless telephones varies, a pocket may be provided for each unique combination of physical and electrical characteristics found among supported communications devices.

The pocket is also adapted for mechanical and electrical interconnection to the docking station. The mechanical interconnection may include the provision of a common mounting system for joining the pocket and docking station together, including electrical contacts, or simply electrical contacts where the docking station is remotely located from the pocket. Electrical interconnections between the pocket and docking station may also be according to a common standard, and may include signal paths for various signals. At least some of the signals present between the pocket and the docking station may be formatted according to the above-mentioned API. According to an embodiment of the present invention, the docking station may be interconnected to any of a plurality of pockets.

The docking station may contain a digital signal processor, Power PC, RISC or other processor for sending and receiving commands transmitted over the pocket docking station communications bus, and for controlling other functions. For instance, the digital signal processor of the docking station may perform various signal processing functions to remove noise, as well as acoustic echos and line echos, from audio signals passed between the telephone and a speaker, as well as from a microphone to facilitate hands-free communications. The digital signal processor may also serve to interpret voice commands issued by a user concerning control of the system. Other potential functions of the docking station digital signal processor include wireless data processing or forwarding, the storage of voice memoranda, text to speech functions, and for interfacing the system to other communication devices, such as personal information managers (PIMs), GPS receivers, vehicle communications busses, Bluetooth devices, and other devices. In accordance with one embodiment of the present invention, multiple processors, each adapted to perform particular tasks, may be provided as part of the docking station.

The docking station may also provide a standard interface for interconnecting external devices to the system. For example, the docking station may provide a network interface, such as an Ethernet network interface. External devices, such as laptop computers, personal digital assistants (PDA) and other devices capable of communicating over such a network may then be interconnected to the system. According to one embodiment, the standard interface is provided as part of a data daughter board that is itself interconnected to the docking station. In addition, the docking station may provide for a standard command set to allow the external devices or applications running on the external devices to control aspects of the wireless communications device's operation. According to another embodiment of the present invention, a cable or interconnection between an external device and the docking station may be provided with componentry to reformat commands as required. Accordingly, the external devices are not required to issue commands formatted according to the proprietary communications interface of the particular wireless communications device associated with the system. The provided command set may be part of the API of the system.

According to one embodiment of the present invention, the pocket in part controls access by a user to the functional capabilities of the system. Accordingly, a pocket may interconnect a communications device to a docking station in such a way that power may be supplied to the device, and audio communications may be passed to and from that device. However, the pocket may not allow for the recording of voice memoranda, even though the docking station may contain the processing, control and storage components necessary to provide that functionality. A second pocket may enable the user to access the voice memorandum recording capability of the docking station. Yet another, third pocket may additionally provide for the storage of voice memoranda in the pocket itself. Accordingly, this third pocket may allow a user to easily take recorded memoranda to, e.g., a docking station type device located in the user's home or office for playback of the memoranda. Still another pocket, used in combination with a suitable docking station, may enable a text to speech functionality. In this way, the system of the present invention allows a single model of docking station to optionally support a wide variety of communications devices and to provide a wide variety of functions. Therefore, the communications devices supported and the functional capabilities of the system can, at least in part, be determined by the pocket used as part of the system.

The system of the present invention allows a user to change, for example, his or her wireless telephone, while continuing to use the system, even where the physical and electrical characteristics of the new wireless telephone are different from the old, by purchasing a new pocket, while continuing to use the original docking station. In general, a user may gain access to additional capabilities by substituting a pocket enabling or providing a first set of capabilities for a pocket that enables or provides those additional capabilities. In this way, the system of the present invention enables a user to change his or her communications device without having to replace the docking station, and to upgrade the capabilities of the system by obtaining a pocket having the desired additional capabilities.

According to another embodiment of the system of the present invention, various models of docking stations may be available, allowing a user to determine the capabilities of the system at least in part by the docking station chosen. Accordingly certain docking stations may have less capabilities and be offered at a lower price than certain other docking stations that are more recent or that are more expensive but that offer expanded capabilities. Different models of docking stations may also be offered to provide or support new features. The various models of docking stations are preferably compatible, at least in part, with any pocket.

According to one embodiment of the system of the present invention, the system can provide a text to speech function to, for example, provide an audio output of textual data received by the communications device. This capability may be built into the docking station, or may be added to the docking station by the addition of a daughter board containing additional componentry to support the text to speech function.

The system is also capable of handling communications involving separately identifiable vehicle subsystems using processing or server functionalities of the docking station and/or associated daughter board. The vehicle having the vehicle subsystems has a unique IP address to allow communications over the Internet. In communications with the vehicle subsystem, the vehicle IP address is utilized outside the vehicle, while inside the vehicle the communication can be mapped to, or otherwise associated with, the particular vehicle subsystem involved with the communication.

Additional advantages of the present invention will become readily apparent from the following discussion, particularly when taken together with the accompanying drawings.

### BRIEF DESCRIPTION OF THE DRAWINGS

FIG. 1A illustrates a system for providing wireless communications in a vehicle according to an embodiment of the present invention;

FIG. 1B illustrates a pocket according to another embodiment of the present invention;

FIG. 2 is a rear perspective view of a pocket according to an embodiment of the present invention;

FIG. 3 is a schematic illustration of a system for providing wireless communications in a vehicle according to an embodiment of the present invention;

FIG. 4A is a schematic representation of a system for providing wireless communications in a vehicle according to an embodiment of the present invention;

FIG. 4B is a schematic representation of a system for providing wireless communications in a vehicle according to another embodiment of the present invention;

FIG. 5 is a schematic illustration of a pocket according to an embodiment of the present invention;

FIG. 6 illustrates functional compatibilities between components of a system for providing wireless communications in a vehicle according to an embodiment of the present invention;

FIG. 7 illustrates the pocket communications state machine according to an embodiment of the present invention;

FIG. 8 illustrates the architecture of the docking station software according to an embodiment of the present invention;

FIG. 9 illustrates a typical communications scenario according to an embodiment of the present invention;

FIG. 10 illustrates a pocket worst case communications scenario;

FIG. 11 illustrates a docking station worst case communications scenario;

FIG. 12 is a block diagram depicting a system in accordance with the present invention interconnecting a plurality of applications to a server;

FIG. 13 depicts a data daughter board in accordance with an embodiment of the present invention;

FIG. 14 is a flow chart illustrating aspects of the operation of a system in accordance with the present invention in response to the receipt of a data packet from an application;

FIG. 15 is a flow chart illustrating additional aspects of the operation of a system in accordance with the present invention in response to the receipt of a data packet from an application; and

FIG. 16 is a flow chart illustrating aspects of the operation of a system in accordance with the present invention in the context of an example.

### DETAILED DESCRIPTION

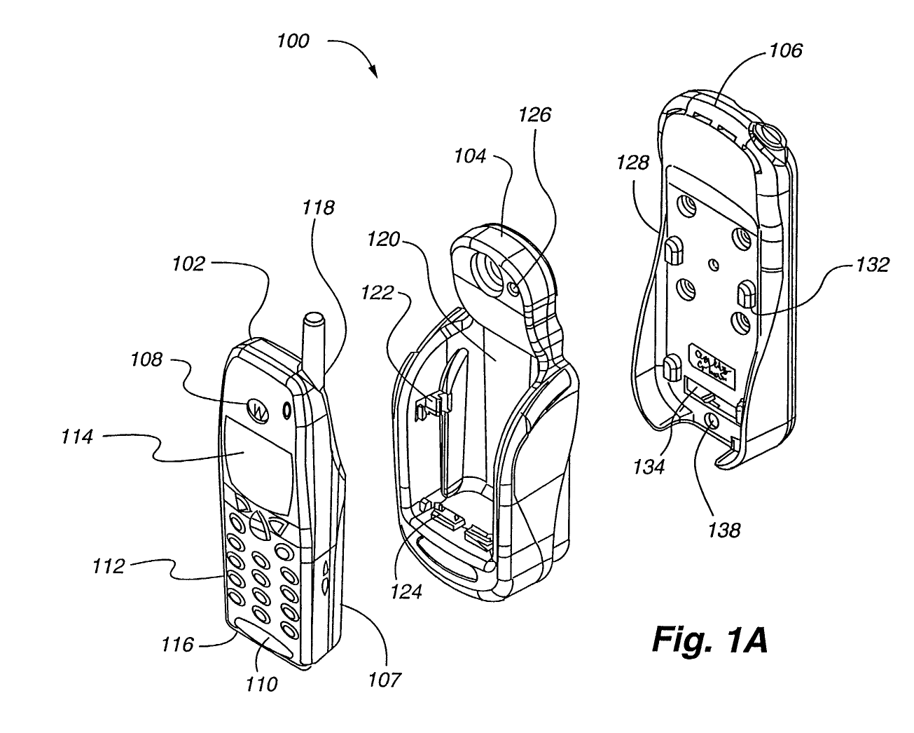

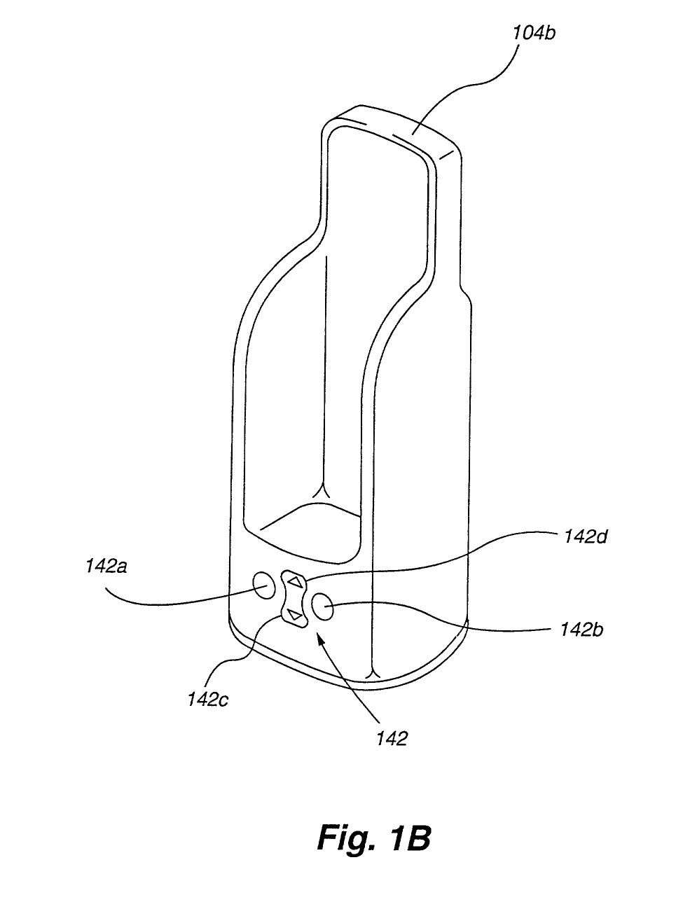

With reference to FIG. 1A, an embodiment of a system 100 for providing wireless communications in a vehicle is depicted. The system 100 generally includes any communications device capable of wireless communications (e.g., a wireless telephone) 102, a first holding assembly or pocket 104, also referred to herein as adaptor 104, and a docking station or an interface module (IM) 106. For purposes of the present disclosure, the terms holding assembly, pocket and adaptor shall be treated as being synonymous. The telephone 102 may have, or be compatible or otherwise operatively associated with, any current or future wireless technology, including, but not limited to, analog technologies such as the Advanced Mobile Phone System (AMPS), or digital systems such as a code division multiple access (CDMA) system, a time division multiple access (TDMA) system such as the Global System for Mobile Communications (GSM), a third generation (3G) system, such as wide band CDMA (W-CDMA), multicarrier CDMA, Time Division Duplex CDMA, or 3G EDGE (Enhanced Data Rates for GSM Evolution), or a combination of these and other air link technologies, such as the Bluetooth standard. In addition, the telephone 102 can be a wireless communications device other than a wireless telephone, such as a satellite telephone, a radio, a software defined radio, a personal digital assistant, with or without wireless telephone capability or other service. In general, the telephone 102 is designed by its manufacturer to operate on batteries 107 and to be small in size to allow for easy portability. In addition, the telephone 102 generally features a built-in speaker 108 and microphone 110 to provide for the input and output respectively of audio signals when the telephone 102 is held to the head of the user.

The telephone 102 includes a keypad 112 to allow the user to dial numbers and to access the internal capabilities of the telephone 102, such as stored directories of telephone numbers, voice mail, paging or other features that may be provided by the telephone 102. User-defined functions such as directories of the telephone numbers may be stored in internal memory provided in the telephone 102. In addition, a typical telephone 102 includes a visual display 114 for displaying the number to be called or other information, such as the contents of a memory location or the number from which an incoming call originates. The telephone 102 will generally include baseband frequency amplifiers associated with the speaker 108 and the microphone 110. The telephone 102 also includes a radio frequency section for transmitting and receiving signals at the telephone's 102 operating frequencies. An electrical connector 116 is generally provided to allow the telephone 102 to be electrically connected to external devices. For example, the telephone 102 may be connected to an external power supply through the electrical connector 116. In addition, the connector 116 generally includes contacts for the transmission of control and data signals to the telephone 102. In some telephones 102, provision may also be made for the interconnection of a coaxial radio frequency cable to a radio frequency port 118, allowing the telephone 102 to utilize an external antenna.

The pocket 104 generally includes a recess 120 shaped to receive the exterior of the telephone 102. The recess 120 may include surface features 122, such as friction pads or protrusions shaped to mate with receiving features on the telephone 102, to mechanically interconnect the telephone 102 and the pocket 104. The pocket 104 is also provided with an electrical connector 124 that mates with the electrical connector 116 of the telephone 102 when the telephone 102 is properly positioned within the recess 120 of the pocket 104. The pocket 104 may also be provided with a coaxial connector 126 for interconnection with a coaxial connector 118 on the telephone 102. Therefore, the pocket 104 is electrically connected to the telephone 102 through the electrical connections 116 and 124 and the coaxial connectors 118 and 126. The pocket 104 may also be provided with componentry to establish a wireless link with the telephone 102.

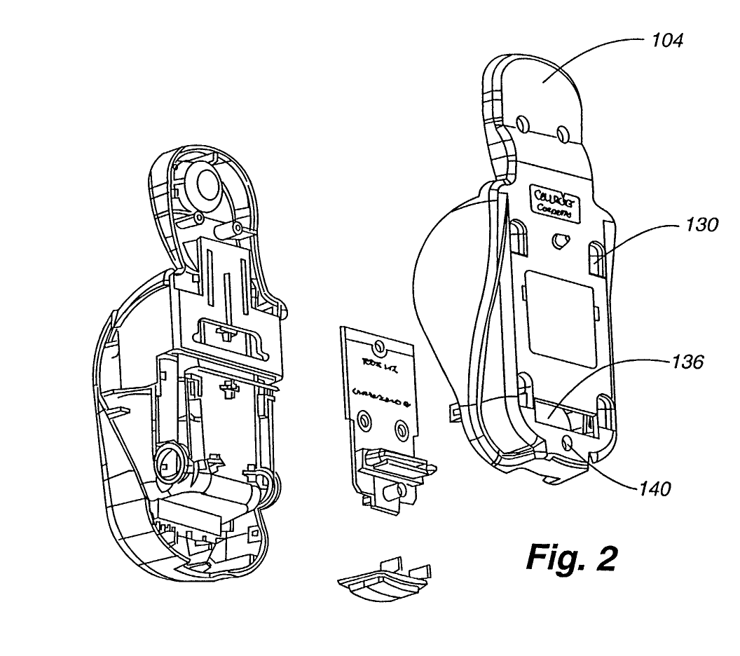

The docking station 106 includes locating protuberances 128 for receiving locating apertures 130 located on the back side of the pocket 104 (see FIG. 2). The locating protuberances 128, together with latch tabs 132 cooperate with the locating apertures 130 to mechanically interconnect the pocket 104 to the docking station 106. The docking station 106 also features an electrical connector 134 that mates with an electrical connector 136 located on the back of the pocket 104 (see FIG. 2). The docking station 106 additionally includes a coaxial connector 138 for connection to a cooperating coaxial connector 140 located on the back of the pocket 104 (see FIG. 2). The docking station 106 may also be provided with componentry to establish a wireless link with the telephone 102 or the pocket 104.

In the system of the present invention, the telephone 102 generally serves to transmit and receive radio frequency signals, and to demodulate and modulate those signals to and from the baseband frequencies (e.g., the audible frequencies or digital data communication frequencies). The telephone 102 then provides the baseband frequencies to the pocket 104 through the mating of the electrical connectors 116 and 124. Alternatively, the telephone 102 may provide the baseband frequencies over a wireless link. The pocket 104 also holds the telephone 102 securely in place. The electrical connector 136 and/or wireless link, in cooperation with the electrical connector 134 on the docking station 106 and/or wireless link provided by the docking station 106 or the pocket 104, completes the electrical interconnection of the telephone 102 to the docking station 106 either directly or through the pocket 104, and in turn to the vehicle. The docking station 106 also serves to mechanically interconnect the pocket 104, and in turn the telephone 102, to the vehicle, as the docking station 106 is generally rigidly affixed to the vehicle. The radio frequency connectors 118, 126, 138, and 140 also cooperate to carry radio frequency signals from the telephone 102 to an antenna mounted on the exterior of the vehicle. Therefore, in summary, the pocket 104 generally serves to mechanically and electrically interconnect the telephone 102 to the docking station 106 and in turn to the vehicle.

Referring now to FIG. 1B, an alternative embodiment of the pocket 104 of the present invention is illustrated. According to the embodiment of the pocket 104 illustrated in FIG. 1B, a plurality of control buttons 142 are provided. The control buttons 142 allow the user to access certain advanced features of the pocket 104 provided with select embodiments of the system 100 and in particular of the pocket 104. These advanced functions will be discussed in detail below.

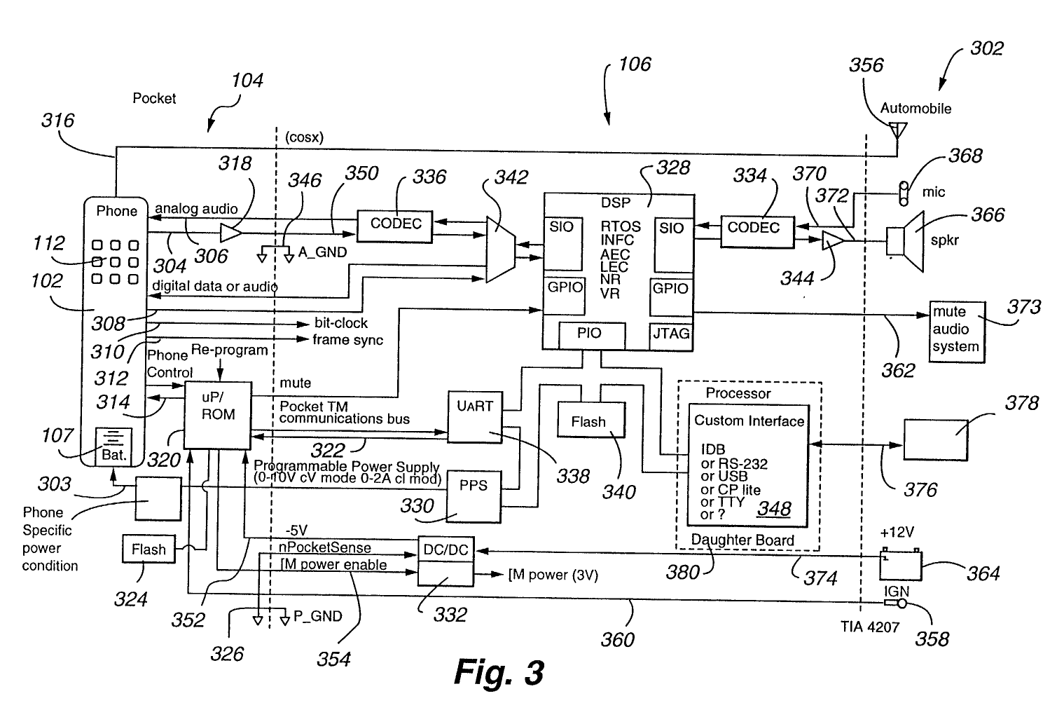

Referring now to FIG. 3, the major internal components of the telephone 102, the pocket 104, and the docking station 106, as well as relevant components integral to the automobile or vehicle 302 are illustrated. As described generally above, the telephone 102 may provide various electronic signal paths. Therefore, the telephone 102 may accept power from an external source through a power supply line 303. The transmission of analog audio signals from the telephone 102 to the pocket 104 may be made through the analog audio output line 304, and analog audio signals may be transmitted from the pocket 104 to the telephone 102 through the analog audio input signal line 306. The telephone 102 may also be provided with one or more signal lines 308 for receiving and transmitting digital data or digital audio signals. Other signal lines that may be provided include a clock signal line 310, a frame synch signal line 312, and telephone control signal bus 314. Telephone control signals passed over the telephone control signal bus 314 may include signals to turn the telephone 102 on or off; to indicate that data is ready to be sent from the telephone, or that the telephone is ready to receive data; to request power or a change in power; to lock and unlock the telephone; to mute the telephone; to indicate an incoming call; to change the telephone language; to auto answer; to convey or request call timer information, current call status, call restriction data, telephone display data, calling number data, serial message data, cellular system information, or telephone system information; to request or control the telephone volume; to recall or write telephone numbers or other information from the telephone's memory; to simulate a telephone keypress; to dial a number; caller identification data; and to initiate the send command or the end command. All of the various electrical lines 303, 304, 306, 308, 310, 312 and 314 may be a part of the electrical connector 116 on the exterior of the telephone 102. The telephone 102 may also be provided with a radio frequency signal line 316 in the form of the coaxial connector 118.

As described above, the pocket 104 is provided with an electrical connector 124 for electrically interconnecting the pocket 104 to the telephone 102. Some of the electrical signals passing through the connector 124 are simply carried through the pocket 104 to the electrical connector 136, and thereby are passed on to the docking station 106 directly. Other of the signals are manipulated or processed within the pocket 104. For example, the analog audio output signal 304 is amplified in the pocket 104 by an analog audio amplifier 318. In addition, a microprocessor 320 processes telephone control signals on the telephone control signal bus 314 that are passed between the telephone 102 and the pocket 104, and communication on the pocket docking station bus 322 passed between the pocket 104 and the docking station 106. Pocket memory 324 may be associated with the microprocessor 320. The pocket memory 324 may be any addressable storage space, such as ROM, RAM, EEPROM, flash memory, or a combination of memory types. All or a portion of the memory 324 may be removable from the pocket 104. The pocket 104 also includes a ground signal 326 for signaling to the docking station 106 through electrical connectors 134 and 136 the presence or absence of the pocket 104.

The docking station 106 includes processing hardware and software including at least one microprocessor and/or a digital signal processor 328, a programmable power supply 330, a DC to DC power converter 332, a near-end coder/decoder (CODEC) 334, a far-end CODEC 336, one or more universal asynchronous receivers/transmitters 338 (UART), and docking station memory 340. The docking station memory 340 may be any addressable storage space, such as ROM, RAM, EEPROM, flash memory or a combination of memory types. All or a portion of the memory 340 may be removable from the docking station 106. The docking station 106 also includes a multiplexer 342, an analog audio amplifier 344, and ground lines 326 and 346 for establishing a common ground between the pocket 104 and the docking station 106. The docking station 106 may additionally include an interface 348 for interconnecting the docking station 106 to various external subsystems 378. The interface 348 may be integral to the docking station 106. Alternatively, the interface 348 may conveniently be mounted to a daughter board 380, also referred to herein as data daughter board (DDB) 380, to facilitate expanding the capabilities of the docking station 106. The daughter board 380 may also have a microprocessor including server capabilities. The daughter board 380 may be interconnected to the digital signal processor 328 by a serial or parallel communications channel. According to a further embodiment, instead of such a daughter board 380, all of the interface's 348 capabilities and the docking station components and their functionalities could be integrated on a single chip. In general, the provision of the interface 348 allows the docking station 106 to serve as a communications hub for various external subsystems 378. These external subsystems 378 may include personal computers, auto PCs, Global Positioning System (GPS) units, Personal Digital Assistants (PDA); devices for the storage of digital audio for playback through the automobile's stereo, such as devices storing music in the MP3 format; the data network or communications bus of vehicles, such as a controller area network (CAN), other data network or communications busses, visual displays; devices using the Bluetooth communications protocol or some other communications protocol; or other electronic systems. In connection with possible implementation of Bluetooth technology, such may be integrated with the docking station 106, as well as being incorporated with the pocket 104. In such a case, the Bluetooth technology need not be part of the wireless telephone 102 or other wireless communication device. According to this embodiment, the pocket 104 and the docking station 106 could cooperatively function to provide services for associated Bluetooth devices. In this configuration, the number of signal conducting wires is substantially reduced. However, one or more wires may be necessary or appropriate for providing charging functions and/or providing an external antenna connection.

With respect to facilitating communications with the vehicle 302 having the wireless communications device 102, particularly communications to vehicle subsystems 378 using the Internet, the vehicle subsystems 378 can be configured to be separately accessible. These individualized communications are achieved, preferably not by assigning separate Internet protocol (IP) addresses to each of the vehicle subsystems 378, but by incorporating an address-related mapping technique. In accordance with the preferred embodiment, the particular vehicle 302 has only one IP address, or at least the number of IP addresses associated with the vehicle 302 and vehicle subsystems 378 is less than the total number of vehicle subsystems 378. In the case in which the vehicle 302 has only one IP address, it is necessary to be able to direct the received communication to the desired vehicle subsystem 378. This can be accomplished by assigning or correlating ports or other identifiers to each of the vehicle subsystems 378 for which there is interest in allowing such communication. When a communication is received for a designated vehicle subsystem 378, the docking station 106 and/or associated daughter board 380 functions to map the contents of the received communication to the port or other identifier associated with a particular vehicle subsystem 378 that is to be the recipient of this communication. In a preferred embodiment in which it is desirable to communicate with a number or a fleet of vehicles 302 from a common site outside the vehicle 302, each of the vehicles 302 in the fleet would be assigned a separate IP address. However, the identifiers or ports associated with each of the vehicle subsystems 378 in this fleet would have the same or corresponding port or other identifier. For example, vehicle subsystem 1 in vehicle 1 would have the same port number or other identifier as vehicle subsystem 1 in vehicle 2, although the IP addresses of vehicle 1 and vehicle 2 would be different. This configuration is highly beneficial in managing fleet vehicles 302, particularly sending/receiving information relative to each of a number of vehicle subsystems 378 in a large number of vehicles. Relatedly, such configuration makes it easier to identify and locate each of the vehicle subsystems 378 in a fleet since the same vehicle subsystem 378 in one vehicle has the same identifier as an identical vehicle subsystem 378 in another vehicle in the fleet.

With regard to sending a first communication to a first external subsystem 378 located in a first vehicle 302, a communication can be prepared at a site remote from the vehicle 302. The communication packet includes an IP address for the first vehicle. The communication packet also includes address-related (e.g., port) information or other identifying information associated with the first external subsystem 378 that is to receive this first communication packet. The first communication packet is transmitted over the Internet to the first vehicle having the IP address in the communication packet. This communication packet is then received by the wireless telephone or other wireless communication device 102. Subsequently, a determination is made regarding the ultimate location or external subsystem 378 recipient of the first communication packet. This determination might be made by processing hardware and software in the docking station 106 and/or other processing hardware/software including possibly a server on the daughter board 380. The docking station 106 may be provided with a network interface, such as an Ethernet Network interface, for providing data packets to recipient external subsystems or devices 378 and applications running on those devices 378. The network interface may conveniently be provided as part of a data daughter board 380. As part of the processing or determination procedures, mapping or other correlation can be provided between the information in the first communication packet related to identifying the particular external subsystem 378 that is to receive the communication packet and a port or other identifier associated with this external subsystem 378. After the mapping is completed, the communication packet can be directed to the determined first external subsystem 378, which was designated as the recipient of this communication. As can be appreciated, in the case in which the same communication is to be sent to the same vehicle subsystem 378 located in a number of vehicles 302 in a fleet, only the IP address for each vehicle 302 need be changed to its dedicated vehicle IP address. As can be further appreciated, when it is desirable to send a communication to a second vehicle subsystem 378 located in the first vehicle 302, either at the same time or at different times, the same IP address associated with that first vehicle 302 can be utilized, while the mapping function to enable the communication to be received by the second vehicle subsystem 378 can be handled within the vehicle 302.

Similarly, in communicating from the vehicle 302 to a site outside the vehicle, such as a common site associated with sending/receiving communications to/from a fleet of vehicles 302, and involving the transmission of data or other information from one or more vehicle subsystems 378 in the vehicle, the network address translation (NAT) can also be accomplished. In particular, the server or other processing hardware/software conducts an address translation by which the vehicle IP address is provided before the communication is sent over the Internet. Such a communication could also include identifying information that identifies the accompanying data as emanating from the particular vehicle subsystem. Consequently, the communication to the site outside the vehicle is accomplished using a single IP address, regardless of which vehicle subsystem might be providing data to the site over the Internet.

Additionally, the docking station 106 is provided with various signal paths for interconnecting the docking station 106 to the pocket 104 and the vehicle or automobile 302. Signal paths between the pocket 104 and the docking station 106 include the analog audio input signal path 306 and the amplified analog audio output signal path 350. Digital data signal paths 308 and clock 310 and frame synch 312 signal paths may also be provided between the pocket 104 and the docking station 106. The pocket docking station communications bus 322 also runs between the pocket 104 and the docking station 106. The bus 322 may be a serial bus or any other appropriate bus. Various power lines may also run between the pocket 104 and the docking station 106, such as the telephone power supply line 303 and the pocket power line 352. The docking station power enable line 354 connects the microprocessor 320 of the pocket 104 to the DC to DC power convertor 332 in the docking station 106. The ground 326 and pocket sense 346 lines also pass between the pocket 104 and the docking station 106. Radio frequency signals are passed through the docking station 106 from the pocket 104 to an antenna 356 mounted on the automobile 302 over the radio frequency signal line 316. Additionally, a signal indicating the position of the automobile's 302 ignition switch 358 is passed through the docking station 106 to the microprocessor 320 of the pocket through the ignition signal line 360.

Signal paths between the docking station 106 and the automobile 302 include the radio frequency signal line 316, which passes from the telephone 102, through pocket 104 and the docking station 106 to the antenna 356 on the automobile 302. In addition, near-end audio input 370 and audio output 372 lines connect the near-end CODEC 334 to the microphone 368 and the speaker 366, respectively. The audio output line 372 passes through an analog audio amplifier 344 before continuing on to the speaker 366. The mute line 362 connects the docking station microprocessor 328 to the entertainment system 373 of the automobile 302. The main power line 374 connects the DC to DC power convertor 332 of the docking station 106 to the electrical power supply 364 of the automobile 302. The ignition signal line 360 passes through the docking station 106, between the microprocessor 303 of the pocket 104 and the ignition switch 358 of the automobile 302. Additionally, one or more custom interface signal lines 376 may connect the interface 348 of the docking station 106 to various other subsystems 378 located in the automobile 302.

As a result of the above-mentioned signal paths, in addition to being mechanically interconnected to the automobile 302, the docking station 106 is electrically connected to certain of the automobile's 302 components. Therefore, the docking station 106 may be interconnected to an antenna 356 provided on an exterior of the automobile 302. Also, the docking station 106 is interconnected to the electrical power supply 364 of the automobile 302, and may also be connected to the ignition switch 358 of the automobile 302 to signal operation of the system 100 when the automobile 302 is running. Speakers 366 located within the automobile 302 may conveniently be utilized by the system 100 to provide an audible signal from the telephone 102. The speakers 366 may or may not be a part of the automobile's 302 audio entertainment system 373. Also, the speakers 366 may be part of a headset worn by the user. For receiving audible signals (e.g., the voice of a user), a microphone 368 may be located within the interior of the automobile 302, and that signal processed by the docking station 106 and provided to the telephone 102 via the pocket 104. The docking station 106 of the system 100 may also be interconnected to the audio system 373 of the automobile 302 to mute signals other than those transmitted from the telephone 102 to the speakers 366.

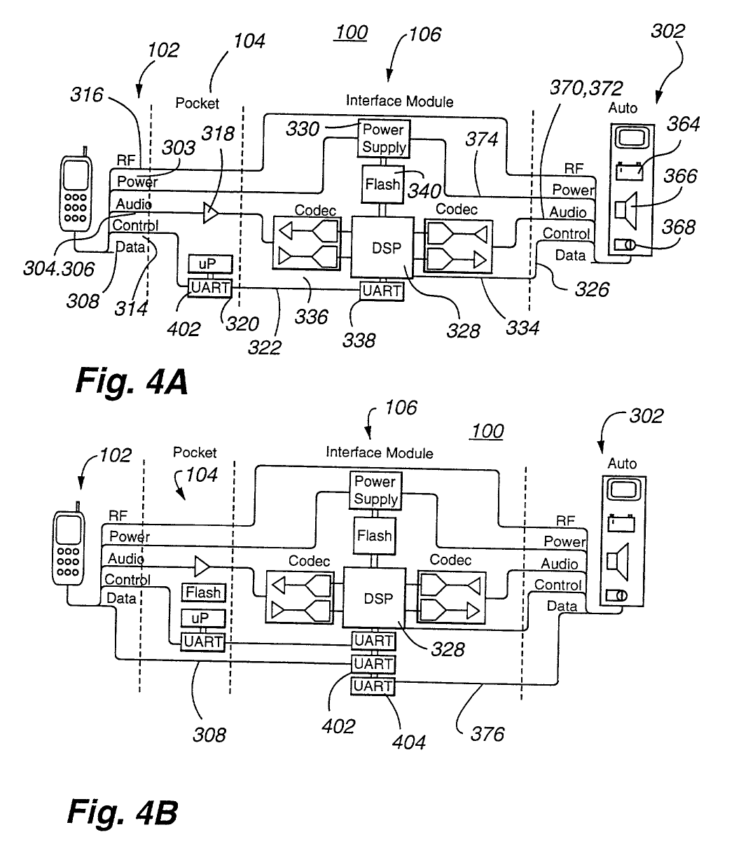

Preferably, the system 100 is provided in a variety of models offering differing capabilities to suit the needs and budgets of individual users. These differing capabilities are provided by varying the functionality supported by the pocket 104 and/or the docking station 106. Referring now to FIGS. 4A and 4B, embodiments of the system 100 having differing capabilities are illustrated schematically.

With reference now to FIG. 4A, a telephone 102, pocket 104, docking station 106, and automobile 302 of an embodiment of the system 100 are illustrated schematically. With respect to the telephone 102, the radio frequency 316, power 303, audio 304 and 306, control 314, and digital data signal lines 308 are illustrated. It is noted that, while the digital data path 308 is shown at the telephone 102, it is not passed through the pocket 104 to the docking station 106. This is because the embodiment of the pocket 104 illustrated in FIG. 4A does not support digital data signals 308, and thus does not provide a digital data line.

The pocket 104 of the embodiment illustrated in FIG. 4A includes signal paths for the radio frequency 316 and power 303 signals. For at least the incoming analog audio signal, an amplifier 318 is provided. Telephone control data line 314 is interconnected to the microprocessor 320 located in the pocket 104. Therefore, it can be seen that, in the embodiment shown in FIG. 4A, the pocket 104 provides interconnections to all of the telephone's 102 electrical inputs and outputs, except for those outputs for digital data or digital audio.

The pocket 104 of the embodiment shown in FIG. 4A amplifies audio signals provided from the telephone 102, and includes a microprocessor 320 for providing an interface for control data 314 passed between the telephone 102 and the docking station 106. As illustrated in FIG. 4A, a universal asynchronous receiver transmitter (UART) 402 may be associated with the microprocessor 320 for aiding the transmission of flow control data between the telephone 102 and the pocket 104. In one embodiment, a single UART 402, which is part of the microprocessor 320, is provided on the pocket 104 side of the telephone control signal path established between the pocket 104 and the docking station 106. Because a UART 338 is provided in the docking station 106, no additional UART is necessary. By eliminating an additional UART, the cost of the pocket 104, and in particular the cost of the microprocessor 320, can be kept to a minimum. However, in certain applications, such as those in which the docking station 106 is located at a distance from the pocket 104, it may be necessary to provide an additional line driver in the pocket 104.

The docking station's 106 major components are shown in FIG. 4A as the docking station microprocessor 328, the power supply 330, the near-end 334 and far-end 336 CODECs, the UART 338, and the docking station memory 340. The docking station 106 is also illustrated as providing a signal path for the radio frequency signal 316. The docking station microprocessor 328 provides a variety of advanced functions that will be described in greater detail below. The power supply 330 provides a constant voltage or a constant current, according to the requirements of the particular telephone 102, for powering the telephone 102 and charging the telephone's 102 battery 107. The CODECs 334 and 336 provide for the conversion of analog audio signals to digital signals that can be processed by the docking station microprocessor 328, and likewise convert digital audio signals emanating from the docking station microprocessor 328 into analog signals usable by the analog audio inputs of the telephone 102 or the speakers 366 of the automobile 302. As described above with respect to the pocket 104, the UART 338 of the docking station 106 facilitates the communication of telephone 102 control data between the pocket 104 and the docking station 106 across the pocket-docking station bus 322. The docking station memory 340 allows voice memos or other data to be stored in digital form. In addition, the docking station memory 340 may be used to store word models and voice prompts used to support voice recognition features. As an additional function, the docking station memory 340 may be used to correct errors in the code resident in the docking station microprocessor 328.

The automobile 302 is, in the embodiment illustrated in FIG. 4A, shown as being connected to the radio frequency 316, power 374, audio 370 and 372 and control 362 line. However, the data line 308 is not shown as being interconnected to the data line 308 of the telephone 102. This is because the pocket 104 of the embodiment makes no provision for transmitting such data 308 to or from the telephone 102.

Referring now to FIG. 4B, a telephone 102, pocket 104, docking station 106, and automobile 302 of yet another embodiment of the system 100 are illustrated schematically. The system 100 illustrated in FIG. 4B includes all of the various signal lines and structures described above with respect to the embodiment illustrated in FIG. 4A. However, in addition, the embodiment illustrated in FIG. 4B includes a digital data line 308 from the telephone 102 through the pocket 104 to a second UART 402 located in the docking station 106. The second UART 402 of the docking station 106 is connected to a third UART 404 in the docking station 106. The interface signal line 376 runs between the third UART 404 of the docking station 106 and the automobile 302. Thus, the embodiment of the system 100 illustrated in FIG. 4B provides a direct path for digital data or audio from the telephone 102 to the docking station 106, including the docking station microprocessor 328, and from the docking station 106 to the automobile 302. The provision of these digital data lines 308 and 376 allows the system 100 to support additional features, as will be described in greater detail below.

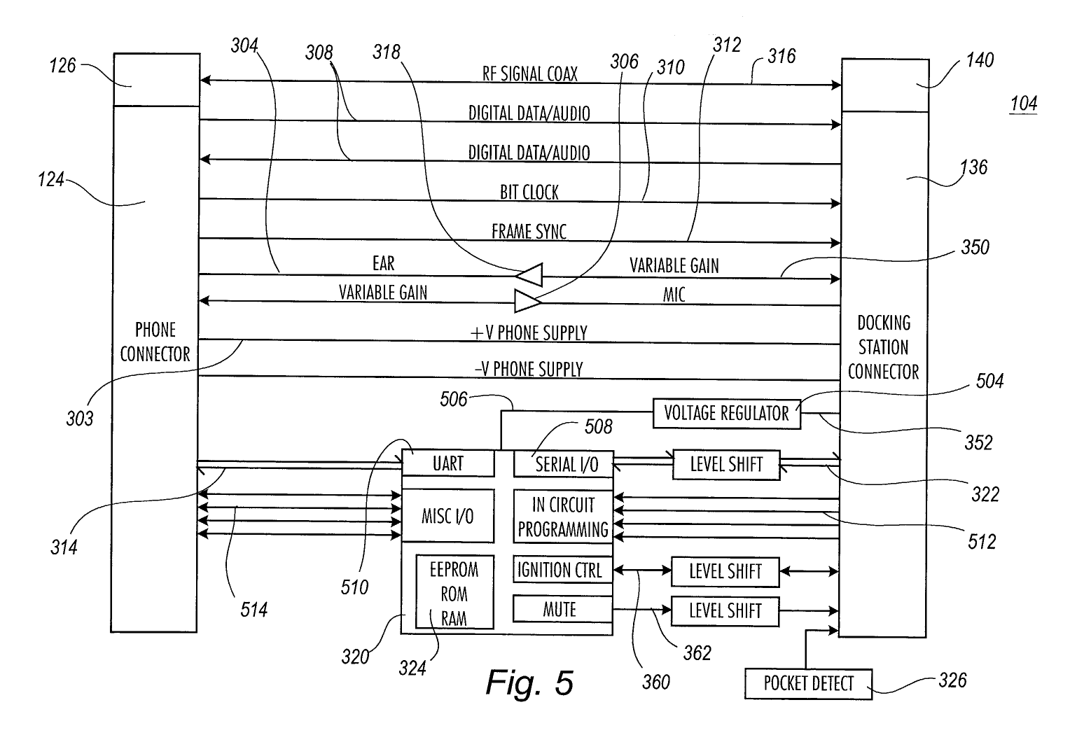

Referring now to FIG. 5, an embodiment of the pocket 104 of the present invention is illustrated schematically. As shown in FIG. 5, the pocket 104 generally includes an electrical connector 124 for providing electrical connectivity between the pocket 104 and the telephone 102. Additionally, a radio frequency connector 126 may be provided for the transmission of radio frequency signals across the pocket 104 to the docking station 106. The radio frequency signal line 316 thus travels between the radio frequency connector 126 at the interface of the telephone 102 and the pocket 104, and the radio frequency connector 140 at the interface of the pocket 104 and the docking station 106. An electrical connector 136 provides other electrical connections between the pocket 104 and the docking station 106. As discussed above, digital data lines 308 can be provided in the pocket 104 to pass digital data or digital audio signals directly from the telephone 102 to the docking station 106, without manipulation by componentry within the pocket 104. Other signal lines that are provided for transmission of signals across the pocket 104 without manipulation by the pocket 104 are the clock signal line 310 and the frame synch signal line 312. Also, one or more power supply lines 303 transmit power from the docking station 106 directly to the telephone 102.

As discussed above, an analog audio amplifier 318 receives analog audio signals from the telephone 102 over the analog audio analog output line 304. The analog signals received at the amplifier 318 are then amplified a selected amount and passed to the docking station 106 over the amplified analog output line 350. Also shown in FIG. 5 is an analog audio input amplifier 502 which may be provided to selectively amplify analog audio signals from the docking station 106 before they are passed to the telephone 102 over analog audio input line 306.

A voltage regulator 504 may be provided in the pocket 104 for providing the correct voltage level to power the microprocessor 320. For example, the voltage regulator 504 may take a 5 volt signal supplied by the DC to DC power convertor 332 in the docking station 106 over power line 352, and produce a 3 volt output. The 3 volt output may then be supplied to the microprocessor 320 over regulated power supply line 506.

The signals provided from the docking station 106 through the electrical connector 136 to the pocket 104 include communication signals transmitted over the pocket-docking station communication bus 322. The communication bus 322 terminates in the microprocessor 320 at serial input/output pins 508. As will be described in greater detail below, the communication signals received at the serial I/O pins 508 are decoded before being sent to the microprocessor UART 510 for transmission to the telephone 102 over the telephone control lines 314. Other signal lines passing between the docking station 106 and the pocket 104 include a plurality of in-circuit programming signal lines 512, which may be used to program or re-program the pocket microprocessor 320. The ignition signal line 360 and mute line 362 are also provided. Additional I/O signal lines 514 may be provided between the microprocessor 320 and the telephone 102. A pocket detect ground 326 for interconnection to the docking station 106 is also provided. Additionally, memory 324 may be provided in the pocket 104 for use in association with the microprocessor 320. According to one embodiment of the pocket 104, the microprocessor 320 includes inputs for receiving signals from buttons 142 (see FIG. 1B) on the exterior of the pocket 104.

As mentioned above, the telephone 102 may generally be used to transmit and receive voice and data signals over an air link to a base station, such as a cell in a cellular phone system. Additionally, the telephone 102 will typically allow for the storage of indexed lists of telephone numbers to provide the user with a customized list or directory of telephone numbers. The telephone 102 is also provided with a speaker 108 and microphone 110 to allow the user to engage in conversations over the telephone 102 when the telephone 102 is held to the face of the user. A keypad 112 is typically used to enter numbers and initiate dialing, answer incoming calls, and to enter telephone directory information. A visual display 114 is also typically provided for displaying the number to be called, memory location entries, or other information. The telephone 102 may be powered by a battery 107 so that the telephone 102 is easily portable.

However, the telephone 102 is typically not provided with features allowing for easy hand held use in an automobile. For instance, placing a call typically requires the user to enter the number using the keypad 112, or again using the keypad 112, to select from an entry in a user-defined directory. Using the keypad requires that the user remove his or her eyes from the road to view the keypad 112 and the display 114, and to remove a hand from the automobile's 302 controls to enter the number or select the desired option. This is, of course, disadvantageous where the user is driving the automobile 302. Although some telephones 102 are available with built-in voice recognition features, they are “near talk” systems, and are not well suited for use in vehicle or other “far talk” environments. Therefore, it is desirable to provide a system to allow the reliable hands-free operation of the telephone 102.

As can be appreciated, the telephone 102 may be produced by any one of a number of manufacturers, who each may produce a variety of different models. Accordingly, the physical shape of the telephone 102, as well as the physical configuration of the electrical connector 116 and the particular signal lines provided by the electrical connector 116 may vary greatly. Additionally, the communications protocol recognized by the telephone 102 is generally proprietary to the manufacturer of the telephone 102 and may vary among telephone 102 models produced by a single manufacturer.

In order to accommodate the variety of physical, electrical, and communications protocol variations among telephones 102, the present invention provides a plurality of different pocket 104 configurations. Thus, a pocket 104 may be provided to mate with the various physical configurations of different telephones 102. Accordingly, the recess 120 and surface features 122 are generally determined by the physical characteristics of the telephone 102 meant to be accommodated by the particular pocket 104. In addition, the electrical connector 124 is physically configured to mate with the electrical connector 116 on the telephone 102. Where the telephone 102 provides a coaxial connector 118 for a radio frequency signal line, the pocket 104 may provide a mating coaxial connector 126. In this way, a particular telephone 102 may mechanically mate with the corresponding pocket 104.

As mentioned above, the particular electrical signal lines provided by telephone 102 and the communications protocol used by the telephone 102 may vary between manufacturers, and even among the various models of telephones 102 produced by a particular manufacturer. Therefore, in order to electrically connect the telephone 102 to the pocket 104 and the docking station 106 and in turn the automobile 302, provisions must be made to accommodate these differences. Accordingly, the pocket 104 may be designed to accommodate the particular configuration and type of electrical signal lines provided by the telephone 102. In a physical sense, this is done by connecting the provided signal lines (e.g., 304, 306, 308, 310, 312, 314, 303 and 316) to the corresponding contacts, if so provided, in the electrical connector 116 and 118 of the telephone 102.

Additionally, the pocket 104 is provided with a microprocessor 320 and associated pocket memory 324 for interfacing with the provided telephone control signals 314 of the telephone 102. In this way, the electrical and communications protocols of the telephone 102 can be accommodated by the particular pocket 104 designed for use with the particular telephone 102. Specifically, the memory 324 of the pocket 104 contains code that allows the pocket 104 to translate between commands formatted in the API of the system 100 and the proprietary communications interface of the telephone 102. Although the pocket 104 is physically and electrically configured for use with a particular telephone or telephones 102, it is desirable that the docking station 106 be capable of operating with any of the provided pockets 104 and associated telephones 102. Providing a common docking station 106 may reduce the cost of the system 100, as only the pocket 104 need be varied to accommodate the wide variety of telephones 102 available in the marketplace. To further increase the advantages gained by using a common docking station 106, many of the components necessary to provide the functions of the system 100 are located in the docking station 106. Conversely, the number and cost of components necessary for the pocket 104 to provide the desired functions are kept to a minimum. In addition, although the docking station 106 may be capable of carrying out a certain number of functions, all of these functions may not be available to a user who has a pocket 104 that allows access to only a limited number of the potentially available functions. Also, the functions supported by a particular pocket 104 may be varied according to the operational functions available using the particular telephone 102 or according to the functions supported by the particular pocket 104.

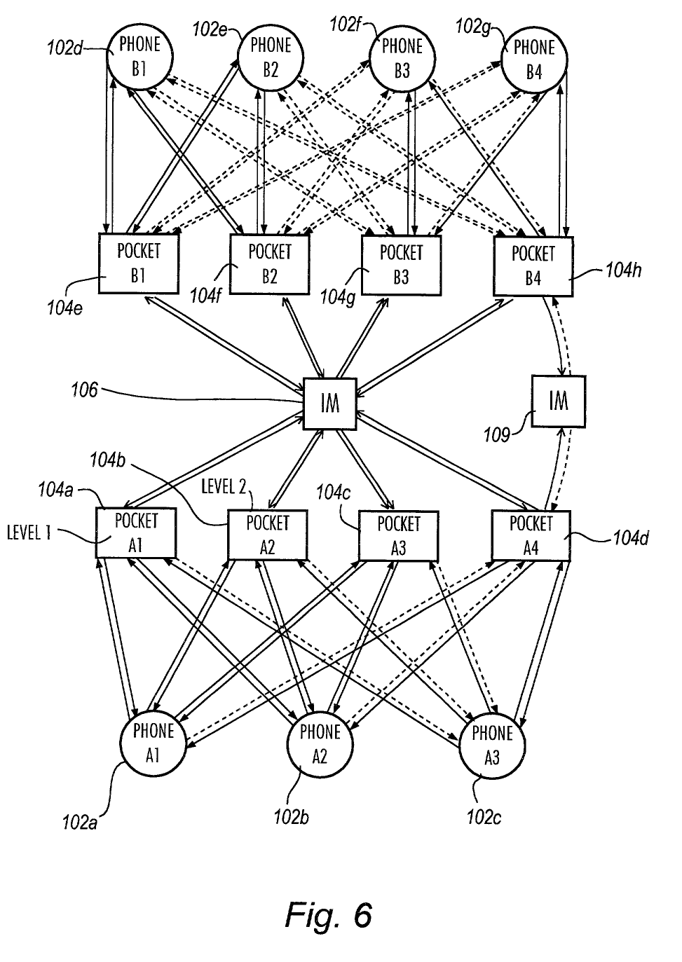

With reference now to FIG. 6, a plurality of pockets 104a, 104b, 104c, 104d, 104e, 104f, 104g and 104h are shown, each having differing physical and/or functional compatibilities, but that are all physically and functionally compatible with a common docking station 106. The pockets A1 104a, A2 104b, A3 104c, and A4 104d may, for instance, be compatible with the physical characteristics of telephones A1 102a, A2 102b, and A3 102c produced by a single manufacturer A. Pockets B1 104e, B2 104f, B3 104g and B4 104h may be physically compatible with telephones B1 102d, B2 102e, B3 102f and B4 102g produced by manufacturer B, or alternatively produced by manufacturer A, but having different physical characteristics from telephone 102a, 102b and 102c. Although in the example the pockets 104a-d are physically compatible with the telephones 102a-c, and the pockets 104e-h are physically compatible with telephones 102d-g, all the various functionalities of telephones 102a-e may not all be supported by the pockets 104a-d and all the various functionalities of the telephones 102d-g may not all be supported by the pockets 104e-h. Similarly, the functional or other capabilities of the pockets 104a-h may not all be supported by all of the telephones 102a-g. In FIG. 6, the functional compatibilities between the individual pockets 104a-h and the individual telephones 102a-g are illustrated by arrows. A solid arrow from a pocket 104 to a telephone 102 indicates that all of the functions of the particular telephone 102 are supported by the particular pocket 104, while solid arrows from a telephone 102 to a pocket 104 indicate that all of the particular pocket's 104 capabilities are supported by the particular telephone 102. A dotted line from a telephone 102 to a pocket 104 indicates that only a subset of the pocket's 104 capabilities are supported by the particular telephone 102, while a dotted line from a pocket 104 to a telephone 102 indicates that only a subset of the particular telephone's 102 capabilities are supported by the particular pocket 104.

As an example, telephones A1 102a, A2 102b, and A3 102c may share common physical attributes, allowing any of those telephones to be mechanically interconnected to any of the pockets A1 104a, A2 104b, A3 104c, and A4 104d. However, the telephones A1 102a, A2 102b, and A3 102c may have differing functional capabilities. Likewise the pockets A1 104a, A2 104b, A3 104c, and A4 104d may support different functions. For instance, pockets A1 104a, A2 104b, and A3 104c may support all of the functional capabilities of telephones A1 102a and A2 102b, but only a subset of telephone A3's 102c capabilities while pocket A4 104d may support all of the functional capabilities of telephones A1 102a, A2 102b and A3 102c. Telephones A1 102a and A2 102b may support all of the functional capabilities of pockets A1 104a, A2 104b, and A3 104c, but only a subset of the functional capabilities of pocket A4 104d, while telephone A3 102c may support all of the functional capabilities of pockets A1 104a, A2 104b, A3 104c and A4 104d. Examples of the interaction between pockets 104 having differing functional capabilities and telephones 102 having differing functional capabilities will now be explained in the context of various examples.

The pocket A1 104a may be a level one pocket supporting only the most basic functions provided by the system 100. Thus, the pocket A1 104a may provide basic speaker phone functions when interconnecting telephones A1 102a, A2 102b or A3 102c to the docking station 106. The basic speaker phone functions may comprise the provision of a speaker 366 and microphone 368, to allow the user to carry on a conversation transmitted over a wireless link by the telephone 102 without having to hold the telephone 102 to his or her face. Thus, with reference now to FIG. 3, the pocket A1 104a may provide analog audio signal lines 304 and 306 to support analog audio signals from and to the telephone 102, where the telephone, e.g., telephone A1 102a, provides an analog audio input and output. The pocket A1 104a may also provide analog audio amplifiers 318 and 502 (see FIG. 5) to allow for the gain of the analog audio signals to be adjusted. The pocket A1 104a then provides connections for the analog audio signals to the docking station 106. Where the telephone A1 102 provides a digital input or output, for example, telephone A2 102b, the pocket A1's 104a digital audio signal lines 308 pass the digital audio signal directly to the docking station 106. In general, the capabilities and specifications of the telephone 102 are communicated to the docking station 106 by the pocket 104 via the pocket—docking station communications bus when the pocket 104 is initially interconnected to the docking station 106.

The pocket A1 104a also may provide a power line 303 for charging the battery 107 of the telephone 102 and/or providing electrical power to operate the telephone 102. The pocket A1 104a additionally includes telephone control signal lines 314 between the telephone 102 and the microprocessor 320. Finally, the pocket A1 104a may provide a radio frequency signal line 316, where a radio frequency output connector 118 is provided by the telephone 102.

According to the embodiment of the system 100 having a level one pocket A1 104a, the telephone 102 is physically held in position in the automobile 302, and is provided with speaker phone functionality. Thus, where a telephone call is placed from a remote site to the telephone 102, the user must generally press a button on the keypad 112 of the telephone 102 to enable communications with the telephone at the remote site. The establishment of the communications link with the remote site is signaled to the pocket 104 by the telephone 102 over the telephone control signal lines 314. The form of the signal given by the telephone 102 is generally proprietary to the manufacturer of the telephone 102. Accordingly, it may consist of a serial digital message, or simply by a change in the voltage at an electrical contact on the telephone 102. The pocket 104, and in particular the microprocessor 320, is programmed to recognize the particular message sent from the telephone 102 to indicate that a call is in progress. The microprocessor 320 then converts the message from the telephone 102 into one complying with the application programming interface (API) of the system 100. This message may be transmitted from a serial I/O port provided on the microprocessor 320 over the pocket-docking station communication bus 322 to the far-end UART 338 and from there to a parallel input/output port provided on the docking station microprocessor 328 of the docking station 106. The docking station microprocessor 328 reviews the call-in-progress message that originated in the telephone 102 and that was translated into the API of the system 100, and generally configures the system 100 so that it is ready to handle the call. In particular, the docking station microprocessor 328 activates the mute signal line 362 to mute any output from the automobile's 302 audio system 373. When the telephone provides an analog audio input 306 and an analog audio output 304, the docking station microprocessor 328 may also activate the analog audio output amplifier 318. Thus, where the telephone 102 provides an analog audio signal, that signal may be amplified by the analog audio amplifier 318 and passed to the docking station 106 wherein the analog signal is digitized by the far-end CODEC 336. The now digital audio signal is then passed to the multiplexer 342 and on to the docking station microprocessor 328 at a serial I/O port. The docking station microprocessor 328 then may perform a variety of signal processing functions on the audio signal. These functions may include acoustic echo cancellation, line echo cancellation, noise reduction, and frequency equalization. The digital signal processor may also provide partial full duplex operation, and automatic volume control functions. The processed digital audio signal is then passed from a serial I/O port of the docking station microprocessor 328 to the near-end CODEC 334 where the digital audio signal is converted back into an analog signal. The analog signal may then be amplified to line level and conditioned in the analog audio amplifier 344 before being amplified by the audio system 373 or by a power amplifier associated with the speaker 366 and output by the speaker 366.

Voice signals from the user in the automobile 302 are picked up at the microphone 368, which may feature built-in noise reduction capabilities, and digitized by the near-end CODEC 344, before being passed to the serial I/O port of the docking station microprocessor 328. Again, various signal processing functions may be carried out in the docking station microprocessor 328, before the digital audio signal is passed to the multiplexer 342 and on to the far-end CODEC 336. The far-end CODEC 336 transforms the digital audio signal into an analog signal that is passed to the telephone 102 for transmission over the air link to the remote site.

Where the telephone 102 provides digital audio inputs and outputs, for example, telephones A2 102b and A3 102c, the transmission of signals through the system 100 is generally as described above, except that the digital audio signals are passed between the telephone 102 and the docking station microprocessor 328 via the multiplexer 342, without any intervening amplification, and without passing through the far end CODEC 336.

The level one pocket A1 104a may also provide the telephone 102 with power for charging the battery 107 and operating the telephone 102 over power line 303. In general, the microprocessor 320 of the pocket 104 will have been programmed to request the proper voltage or current from the programmable power supply 330 of the docking station 106. Of course, the power needs of the telephone 102 may vary according to the operational state of the telephone 102 or the charge of the battery 107. Therefore, the telephone 102 may request, for example, that power be supplied at a first voltage when the telephone 102 is in an idle state, and at a second voltage when the telephone 102 is in an active state. The signal requesting differing voltages may be passed from the telephone 102 over the telephone control signal lines 314 to the microprocessor 320 where the request is translated to the API of the system 100. The docking station microprocessor 328 may then control the programmable power supply 330 to provide the requested power. The pocket may also include a current limiter or voltage regulator as required.

Because the pocket 104 is designed to provide a predetermined set of functionalities and to be used with a predetermined telephone or set of telephones 102, the microprocessor 320 and in particular the memory 324 associated with the microprocessor 320 will have been programmed to translate the particular signals of the telephone 102 into commands included in the API of the system 100. In addition, the pocket 104 will have been programmed with the power requirements of the telephone 102. This information regarding the functions supported and requirements of the telephone 102 may be communicated over the pocket-docking station communications bus 322 to the docking station microprocessor 328 when the pocket 104 is plugged into the docking station 106. The pocket 104 also communicates information regarding the functions supported by the pocket 104 to the docking station 106. In general, the docking station 106 is activated when the pocket 104 is plugged into the docking station 106 and the pocket sense ground 326 is established between the pocket 104 and the docking station 106.

A second pocket 104b, known as a level two pocket, may provide additional functionalities. For example, the pocket 104b may support audible prompts, voice commands and voice memorandum recording. As illustrated in FIG. 6, the functionalities of pocket A2 104b are fully supported by telephones A1 102a, A2 102b and A3 102c, even though it provides this additional functionality. Also, the docking station 106 may be identical to the one described with reference to pocket A1 104a. With respect to the basic speaker phone functions provided by the system 100 in connection with pocket A2 104b, the functions and interconnections are as described above with respect to the pocket A1 104a.

In order to support voice commands, the pocket A2 104b must be programmed to convey appropriate messages between the telephone 102b and the docking station 106. For instance, the pocket A2 104b must be capable of providing the telephone 102 with a telephone control signal directing the telephone 102 to pick up an incoming call. This is in contrast to the example given above with respect to pocket A1 104b in which the user must press a button on the keypad 112 of the telephone 102 to pick up an incoming call. In addition, the microprocessor 320 of the pocket 104b must include API commands for functions such as answering an incoming call. Apart from enabling additional functionalities such as voice recognition and voice memorandum recording, the pocket A2 104b is, according to one embodiment of the present invention, the same as pocket A1 104a.

Audible voice prompts are, according to an embodiment of the system 100 of the present invention, provided to guide a user operating the system 100. Audible prompts are particularly advantageous when used in connection with voice recognition functions because they facilitate operation of the system 100 without requiring that the user look at the system 100 itself. For example, the system 100 may acknowledge commands given by the user, or provide the user with information concerning the status of the system 100. The audible prompts may be pre-recorded and stored in the pocket memory 324 and/or the docking station memory 340, with or without compression. Alternatively or in addition, the audible prompts may be generated from text stored in memory 324 or 340 using a text to speech functionality (described below). According to one embodiment, the voice prompts are stored in easily changed memory 324 or 340 cartridges, to allow the existing system 100 to be upgraded, or to accommodate a different or an additional language.

The docking station 106 may include speech recognition functions to enable the system 100 to recognize voice commands. The docking station used in connection with pocket A2 104b may be identical to the docking station 106 used in connection with pocket A1 104a. Alternately, the docking station 106 used in connection with pocket A2 104b may be enhanced to provide voice recognition functions. Even if the docking station 106 is provided in various models offering differing capabilities, any docking station 106 is preferably compatible, at least in part, with any pocket 104. In general, speech models are stored in the docking station memory 340 or the pocket memory 324 to enable the system 100 to recognize universal commands such as “answer call” or “place call.” Different memory 324 or 340 cartridges may be provided to conveniently upgrade the speech models or change them to a different language. In addition, provision may be made in the docking station 106 for storing user defined commands, such as “call home” or “call Mary.” According to one embodiment of the present invention, the user defined commands and voice memoranda may be stored in removable memory 324 or 340 to facilitate their use in other systems 100 or in compatible devices, to archive memoranda, or to allow the use of different command sets. The removable memory 324 or 340 may comprise a RAM memory card. The pocket A2 104b may be provided with buttons 142 (see FIG. 1B) to enable the user to signal the system 100 to enter a voice command mode or voice memo record mode.

The operation of the system 100 in processing a voice command will now be explained in the context of an example. Where a telephone call is not in progress (i.e. the telephone 102 is on-hook), a user may command that a general voice recognition mode be entered by uttering a special initiator word (e.g., “CellPort”). The system 100 may also be provided with a “barge-in” capability to allow voice recognition mode to be entered even while a telephone call is in progress (i.e. the telephone 102 is off-hook). Alternatively, the user may press a button 142a provided on the exterior of the pocket 104b to place the system 100 in voice recognition mode. Upon receiving the signal to enter voice recognition mode, the processor 320 sends a message across the pocket-docking station communication bus 322 to the docking station microprocessor 328 via the UART 338. The message sent by the microprocessor 320 is formatted according to the API of the system 100. Upon receiving the message to enter voice recognition mode, the docking station microprocessor 328 activates or otherwise communicates with the microphone 368. When a voice command is used, the docking station microprocessor 328 will cause the system 100 to enter a general voice recognition mode after a prescribed voice command has been issued by the user.

Voice commands issued by the user are converted into analog electrical signals by the microphone 368 and passed through the near-end CODEC 334, where the analog signals are digitized. The digitized voice commands are then compared in the docking station microprocessor 328 to the standard and customized speech models stored in the flash memory 340. If, for example, the user issues the command “call home,” the docking station microprocessor 328 will attempt to match those words to the stored word models. Upon finding a match, the docking station microprocessor 328 will initiate action according to the command. Thus, when the command “call home” is received, a signal to initiate a telephone call will be formatted in the API of the system 100, and passed to the microprocessor 320 of the pocket A2 104b, where the API command is translated into a signal understood by the telephone 102. Where the telephone number associated with “home” is stored in memory 324 or 340, the command to the telephone 102 may consist of the digits of the telephone number and the send command. Alternatively, where the telephone 102 allows access to telephone directories stored in its internal memory, the command from the docking station microprocessor 328 may be in the form of a command to retrieve a number from a specified memory location in the telephone 102 and to initiate the send function.

The functions provided by the level two pocket A2 104b may also include provisions for voice memo recording. Thus, by pressing the associated buttons 142b, or by issuing the appropriate voice command, such as “take a memo”, the system 100 may be configured to record a voice message. Such a capability is useful, for instance where a user wishes to give him or herself a reminder to do something without having to write the reminder down with pencil and paper. The voice memorandum capability is also useful for recording directions or a telephone number given by the person at the other end of the communications link. In voice memo recording mode, the voice message is converted to an analog electrical signal by the microphone 368 and transmitted to the near-end CODEC 334 where the signal is digitized. The digital voice memo is then processed and compressed by the docking station microprocessor 328 and stored in memory 340. When the user wishes to retrieve the voice memo, the user may press a button 142c on the pocket A2 104b causing a command to be sent from the microprocessor 320 across the pocket-docking station communication bus 322 to the docking station microprocessor 328, in the API of the system. The docking station microprocessor 328 then retrieves the message from memory 340, decompresses the message, performs signal processing functions, and provides a digital output of the message to the near-end CODEC 334, which converts the memo to an analog signal that is then amplified by the amplifier 344 and output at the speaker or headset 366. Where the command to replay a previously recorded voice memo is in the form of a voice command, the recognition of the voice command by the docking station microprocessor 328 initiates the retrieval of the voice message from memory 340 for playback through the speaker 366. In addition or as an alternative to playback through the speaker 366, the memorandum may be transmitted to another device for playback. For example, the memorandum could be transmitted by the telephone 102 to a remote telephone or device, or it could be transmitted to a computer or other external subsystem 378 for playback.

A next level of functionality may be provided by the system 100 in connection with a pocket A3 104c. The additional functions provided by the pocket 104c may include storage for voice memos, directories and customized voice commands in the pocket 104. As illustrated in FIG. 6, the functionalities of pocket A3 104c are fully supported by telephones A1 102a, A2 102b and A3 102c. The docking station 106 may be identical to the docking station used in connection with any of the pockets A1-A4 104a-c and B1-B4 104e-h. The functionalities pocket A3 104c shares with pockets A1 104a and A2 104b may be executed in the same manner as described above.

The pocket A3 104c is provided with memory 324 sufficient to allow the recordation of voice memos and for the storage of voice commands and directories programmed by the user in the pocket A2 104c. In addition, a UART may be provided in the pocket A3 104c to synchronize the transfer of voice memos and voice command data between the docking station 106 and the pocket 104. In general, the voice memo recording function using the pocket A3 104c is identical to the function when carried out by pocket A2 104b. However, the provision of additional memory 324 in the pocket A3 104c allows for voice memos to be stored in the pocket A3 104c. According to one embodiment of the present invention, voice memoranda may be stored in the pocket memory 324 as each memorandum is recorded. Alternatively, voice memoranda may be stored initially in the docking station memory 340, and later transferred to the pocket memory 324 automatically when the system 100 has the resources available to complete such a transfer. As yet another alternative, the user may initiate a transfer of voice memoranda data to the memory 324 in the pocket A3 104c by, for example, pressing a button provided on the pocket A3 104c or by issuing an appropriate voice command. Control logic provided in the pocket microprocessor 320 and/or the docking station microprocessor 328 may be provided to control whether data already written to the memory 324 is overwritten by new data. For example, the user may be notified when the memory 324 is full, and given a choice as to whether old data should be overwritten. After the voice memoranda has been transferred to the pocket memory 324, the pocket A3 104c, which is easily disconnected from the docking station 106, can then be taken to, for example, the user's office. The pocket A3 104c may then be interconnected to a device in the office having a microprocessor and associated speaker, similar to the docking station 106, for playback of stored messages. The UART 402 in the pocket A3 104c allows the memo data to be transmitted over a dedicated line for storage in the pocket A3 104c.

The ability to store customized directories and voice commands in the pocket A3 104c allows a user to use those customized features in any car equipped with a suitable docking station 106. Therefore, by moving the telephone 102 and the pocket A3 104c different users may share an automobile, while retaining access to their own directories and commands. This feature is also useful where a user rents an automobile provided with a docking station 106, as all of the user's personalized information can be carried in the pocket A3 104c.

A further level of functionality may be provided by the system 100 in connection with pocket A4 104d. As illustrated in FIG. 6, the functionalities of pocket A4 104d are fully supported by telephone A3 102c, but only partially supported by telephone A1 102a and telephone A2 102b. Pocket A4 104d fully supports the functionalities of telephones A1-A3, 102a-c. The additional functionalities provided or enabled by pocket A4 104d may include text to speech capability. The text to speech function allows the system 100 to convert information received in the form of written text to audible speech. However, the text to speech function generally requires a telephone 102 capable of receiving textual information. According to the example illustrated in FIG. 6, telephone A3 102c is the only telephone from manufacturer A having e-mail or Internet browsing capabilities. In the example of FIG. 6, telephones A1 102a and A2 102b lack the capability to receive information in the form of text and therefore cannot fully support the text to speech function. However, it should be noted that some text to speech capability may be possible in connection with telephones A1 102a and A2 102b, for example where information in the display 114 of the telephone 102a or 102b, such as caller ID information, is provided at the electrical connector 116 of the telephone 102a or 102b, in which case the information can be presented to the user as audible speech. In addition, the text to speech function may service other subsystems 378 capable of providing textual output. Generally, the pocket 104d provides all of the functions described above with respect to pockets A1-A3, 104a-c.

The pocket A4 104d is provided with commands in the microprocessor 320 to support the receipt of textual information from the telephone 102c. The information received by the telephone 102c is formatted into the API of the system 100 by the microprocessor 320 and transmitted to the docking station 106 over the digital data signal line 308 or the pocket-docking station communication bus 322. According to one embodiment of the present invention, the docking station 106 for use in connection with the pocket A4 104d includes an additional processor at the custom interface 348, which may be conveniently mounted on a daughter board 380, for performing the text to speech function. Generally, the processor at the custom interface 348 transforms the received text into digitized speech, which can then be passed to the docking station microprocessor 328, and from there to the near-end CODEC 334 for conversion to an analog audio signal. The analog audio signal is then output through the speakers 366. The use of an additional processor at the custom interface 348, which can be added to the normal docking station 106, is desirable in that it allows for the use of a specialized processor for handling the relatively complex text to speech translation function. Additionally, it allows docking stations 106 not intended for use with a text to speech enabled pocket 104 and telephone 102 to be produced at a lower cost. As alternatives, the docking station microprocessor 328 may be sufficiently powerful or robust to perform the text to speech function, or an enhanced docking station 109, having a text to speech enabled docking station microprocessor 328 may be offered in addition to the normal docking station 106. As a further alternative, an enhanced microprocessor 320 in the pocket, or an additional microprocessor, may be provided in the pocket A3 102c to handle the text to speech function. Apart from enabling additional and/or different functionalities, such as text to speech, the pocket A3 104c is generally the same as pocket A1 104a and A2 102b.

In connection with the above description of pockets A1-A4 104a-d and their functional capabilities, a user may generally choose the capabilities of the system 100 according to the user's needs and desires by choosing the appropriate pocket A1-A4 104a-d. Thus, a user owning any of telephones A1-A3 102a-c can choose a system 100 having basic hands-free capabilities by purchasing pocket A1 104a and docking station 106. By purchasing pocket A2 104b and a docking station 106, a user may obtain voice command and voice recording capabilities. The use of pocket A3 104c in connection with a docking station 106 provides the user with a system 100 that allows voice memos and programmed voice command information to be stored in the easily transported pocket A3 104c. Accordingly, it is the pocket A1 104a, A2 104b, or A3 104c that determines what capabilities the system 100 provides when used in connection with either a telephone A1 or A2 102a or 102b. Also, when purchasing a new pocket 104 in order to obtain advanced features or to accommodate a different telephone 102, the user need not replace the docking station 106. Furthermore, the same docking station 106 may be used in connection with pockets A1-A3 104a-c.

A system 100 providing text to speech capabilities may be obtained by using a docking station 106 with an additional or an enhanced processor or an enhanced docking station 109, pocket A4 104d, and telephone A3 102c. Although the docking station 106 or 109 used in connection with pocket A4 104d in this example provides enhanced capabilities, it should be noted that, except for the text to speech function, pocket A4 104d is fully supported and fully compatible with the general docking station 106. Similarly, pocket A4 104d can be used with telephones A1 or A2 102a or 102b.

With continued reference to FIG. 6, the relationship between telephones B1-B4 102d-g, pockets B1-B-4 104e-h, and docking station 106 are illustrated. In general, pockets B1-B4 104e-h provide the four levels of functionality described above with respect to pockets A1-A4 104a-d, but are designed to physically and electrically interconnect with telephones B1-B4 102d-g produced by manufacturer B. However, the pockets B1-B-4 104e-h are designed to work with the same docking station 106 as pockets A1-A4 104a-d.

As shown in FIG. 6, pockets B1 and B2 104e and 104f are fully compatible with telephones B1 and B2 102d and 102e, but only partially compatible with telephones B3 and B4 102f and 102g. Additionally, pockets B3 and B4 104g and 104h fully support the functional capabilities of telephones B3 and B4 102f and 102g, but are only partially compatible with telephones B1 and B2 102d and 102e. This situation may occur, for instance, where telephones B1 and B2 102d and 102e feature an older interface used by manufacturer B, while telephones B3 and B4 102f and 102g use a newer interface. Therefore, even though the telephones B1-B4 102d-g may have the same physical characteristics, changes to the interface used to control and send data to and from the telephones 102d-g will affect their compatibility with the pockets 104e-h. According to an embodiment of the system 100, where a user has upgraded their telephone 102, but wishes to use a pocket having an interface adapted for an earlier model of the telephone 102, provided that the telephone 102 and pocket 104 are still physically compatible, the pocket 104 can be upgraded by modifying the memory 324 of the pocket 104 to enable the pocket 104 to properly interact with the telephone 102.

Modifications to the memory 324 may be made by transmitting the upgrade to the memory 324 through a physical connection to a component of the system 100. For example, the pocket 104 may be connected to a personal computer that has been used to download a programming upgrade from an Internet website, or to read new programming code distributed on a floppy disk, CD ROM, or other storage medium. Alternatively, the docking station 106 could be connected to a personal computer, and new programming code loaded onto the memory 340 of the docking station 106. Regardless of whether the pocket 104 or the docking station 106 is used to initially receive the updated programming code, the programming code resident in the pocket memory 324, the docking station memory 340 or both can be modified using the above-described methods. Where a telephone 102 capable of downloading information from the Internet is available, that telephone 102 may be used to download new programming code to upgrade the pocket 104 and/or the docking station 106. Another method of upgrading the programming code of the system 100 is for the user to purchase an upgraded pocket 104 that contains new programming code for upgrading the code stored in the docking station memory 340. Similarly, a docking station 106 containing the necessary code may be used to upgrade the code resident in the pocket memory 324. As yet another method of upgrading the code resident in the memory 324 or 340, all or portions of the memory 324 or 340 may be augmented or replaced by memory 324 or 340 having upgraded programming code.

However, modifying the memory 324 to properly translate between a new telephone interface and the API of the system 100 will not be sufficient where the manufacturer has made changes to the physical configuration of the telephone 102. Also, changes to the memory 324 alone will not be sufficient where the user has, for instance, purchased a new telephone from a different manufacturer having a different physical configuration. In these instances, compatibility with the system 100 may be regained by purchasing a new pocket 104 that is compatible with the user's new telephone 102. The purchase cost of a pocket 104 is preferably much less than the purchase cost of both a pocket 104 and a docking station 106, as the docking station 106 originally purchased by the user may be used with the new pocket 104.

The multiple-processor multiple-bus configuration of the system 100 allows the system 100 to be designed using modular units. In particular, the system 100 provides a pocket 104 for at least every combination of physical and electrical characteristics found in supported telephones 102. The system 100 allows the use of a common docking station 106 by converting the unique physical and electrical characteristics of supported telephones 102 to a common electrical and physical interface at the pocket 104. Therefore, common system components can be placed within the docking station 106, while particular attributes required by particular telephones 102 can be accommodated by the pocket 104. In this way, the cost of the system 100 can be reduced and the flexibility increased.

The application programming interface (API) of the system 100 is the common language used to communicate commands and information between the pocket 104 and the docking station 106. Translation between the interface of the telephone 102 and the API of the system 100 is performed in the pocket 104, and in particular in the microprocessor 320. After translation in the microprocessor 320, commands and information originating at the telephone 102 can be transmitted using the API to the docking station 106 over the pocket-docking station communication bus 322. Commands and data originating at the docking station 106 and at the system 100 follow the reverse course, with commands and data formatted in the API of the system 100 being translated into the telephone's 102 unique interface at the microprocessor 320 of the pocket 104.

Where the system 100 is to be interconnected with subsystems 378 in addition to the telephone 102, an additional processor or custom interface 348 may be provided to perform translation between the API of the system 100 and the interface of the subsystem 378 to which the system 100 is interconnected. Preferably, the custom interface 348 may be provided in the form of an add-on or daughter board 380 that can be interconnected to the docking station microprocessor 328 using provided electrical contacts. Thus, connectivity to various other subsystems 378 may be achieved without requiring changes to the docking station's 106 main components or to the pocket 104 presently in use. Alternatively, or in addition, the subsystem 378 can communicate using the API of the system 100, without requiring any translation. For example, the interface required to communicate with an external subsystem 378 may be resident in the docking station 106. The custom interface 348 and daughter board 380 may simply provide a mechanical connection, or may not be provided at all where the external subsystem 378 interface is resident in the docking station 106.

As mentioned above, the external subsystem 378 may comprise a variety of electronic devices. The subsystem 378 may include protocol based units and close-ended devices. The protocol based units can include networks and busses having associated components or peripheral devices that are interconnected. The close-ended devices are referred to herein as devices that do not have International Standards Organization (ISO) network layering and typically constitute a terminating communication node in the context of data flow ending or originating from such device, and not typically acting as a link or pass-through device for information or data transfers. An example of such a close-ended device might be a global positioning system (GPS) that is useful in providing vehicle location information, or a hardware device, such as a vehicle sensor, from which data can be obtained for a particular vehicle component to which the sensor is operably connected.

In addition to the GPS, the external subsystem 378 may include an Internet Protocol (IP) stack comprised of a number of network layers that are commonly involved in transfers using the Internet. The external subsystem 378 can also include an intelligent transportation system data bus (IDB) and/or an on-board diagnostics (OBD) system that are involved with monitoring and providing information related to vehicle components.

The external subsystem 378 may also include computing devices, such as laptop or notebook computers, PDA's, or other devices. The external subsystem 378 may also include applications running on such devices. In particular, the external subsystem may include Internet aware applications or other applications capable of passing data to or from another application over a communications link.

The external subsystem 378 may also include a controller area network (CAN) found in at least some vehicles and which includes a bus along which a number of vehicle elements communicate for supplying information concerning such elements. The CAN is operatively connected to each of a plurality of vehicle devices that transmit, receive, or both transmit and receive desired data. For example, the vehicle devices include transducers or other physical devices that detect and provide information useful to applications software for processing to obtain information that is then transmitted for storing in memory for later transmission, or even for immediate transmission without processing, upon receipt of the proper request or command. Other available networks could be utilized, instead of CAN, such as Arcnet, which has a protocol similar to CAN. Where the external subsystem 378 includes one of a plurality of vehicle busses, the hardware supplied for interconnecting the external subsystem to the docking station 106, such as the daughter board 380, may include provisions for signaling to the docking station microprocessor 328 the format of the output required by the particular external subsystem 378. For example, the daughter board 380 may comprise cabling, and the presence or absence of a resistor between two signal paths may be used to indicate to the microprocessor 328 the proper voltage at which signals are to be transferred to and from the external subsystem 378. For further information regarding obtaining information or data from vehicle devices, see U.S. Pat. No. 5,732,074, filed on Jan. 16, 1996 and assigned to the assignee of the present invention. The external subsystem 378 may also comprise an analog/digital converter (ADC), a standard serial bus, a universal serial bus (USB), an RS232 connection, a user datagram packet/Internet protocol stack, as well as one or more other custom proprietary devices.

Other devices that may comprise the external subsystem 378 may include a PCMCIA (Personal Computer Memory Card Interface Association) unit, which may include a storage device for storing desired information or data. The external subsystem 378 may also include a device capable of communication using the Bluetooth protocol, which provides a standard protocol for the wireless communication of information between disparate devices.

The protocol used for communications between the pocket 104 and the docking station 106, according to an embodiment of the present invention, is half duplex. Accordingly, there can only be one message in the pocket-docking station bus 322 at any one time. Normally, messages are responded to with either an ACK, acknowledging correct receipt of the message, or a NACK, indicating a problem. A response may be suppressed by issuing a “do not acknowledge” command with the message. In general, the combined message-response pair must be completed before another message can be placed on the bus. A time out period for failed messages may be established, and messages not receiving an acknowledgment within a selected period of time (e.g., 1 second), will be retransmitted up to a selected number of times (e.g., 8 times).

According to an embodiment of the present invention, the pocket 104 acts as the bus master, and the docking station 106 acts as the slave. As master, the pocket 104 may issue API commands to the docking station 106 at any time. Periodically, the pocket 104 issues a bus grant message to the docking station 106 after which the docking station 106 may send a command to the pocket 104. After receiving the bus grant message, the docking station 106 can either send a pending message or reply with a bus release message. According to an embodiment of the present invention, the bus grant message is sent once every second, and the docking station 106 has 500 ms to issue a pending message or a bus release message.

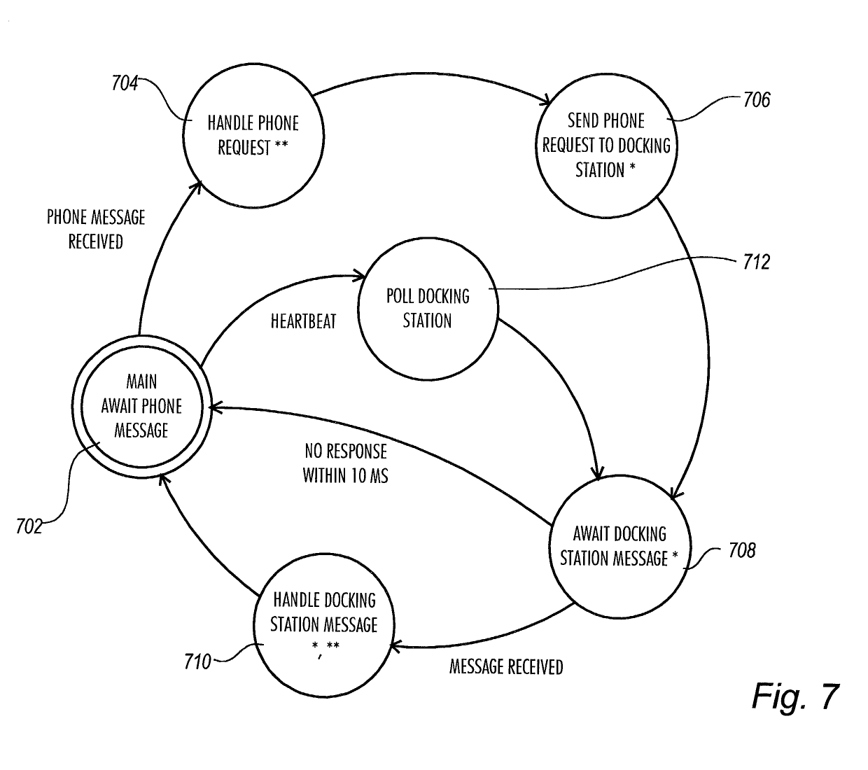

With reference now to FIG. 7, the pocket communications state machine in accordance with another embodiment of the present invention is illustrated. Generally, as noted above, the pocket 104 and the docking station 106 are in a master and slave relationship. As shown in FIG. 7, at state 702, the pocket 104, and in particular the microprocessor 320, awaits a message from the telephone 102. Upon receiving a telephone message, the pocket 104 enters state 704 in which the telephone request is handled. After handling the telephone request, the pocket 104 then enters state 706 in which the telephone request is sent to the docking station 106. Next, the pocket 104 awaits a message from the docking station 106 in state 708. If no message is received from the docking station 106, the pocket 104 then returns to state 702. A system 100 also includes the timer that operates in cooperation with determining whether or not a message is received. During normal operation, when no response is received from the docking station 106, another pulse or heartbeat is sent at predetermined times. However, if there is no response within a time interval associated with the timer timing out, a hardware reset line is enabled to reset the docking station 106. Where a docking station 106 message is received, the pocket handles the message in state 710, following which it returns to state 702. Where no telephone message is received, the pocket 104 periodically polls the docking station 106 at state 712. According to an embodiment of the present invention, the pocket 104 polls the docking station 106 every 72 milliseconds (i.e. the pocket 104 heartbeat rate is 72 milliseconds). After polling the docking station 106 in state 712, the pocket 104 enters state 708 in which it awaits a message from the docking station 106. If no message from docking station 106 is received within 10 milliseconds of polling the docking station 106, the pocket 104 returns to state 702, in which it awaits a telephone 102 message. According to one embodiment of the present invention, communications between the pocket 104 and the docking station 106 occur at 19,200 baud, using eight data bits, one parity bit, and no stop bit. According to another embodiment of the present invention, the data between the pocket 104 and the docking station 106 is transmitted at 115200 bps, using 8 data bits, no parity, and one stop bit. However, other communication rates can be used, and may even be varied.

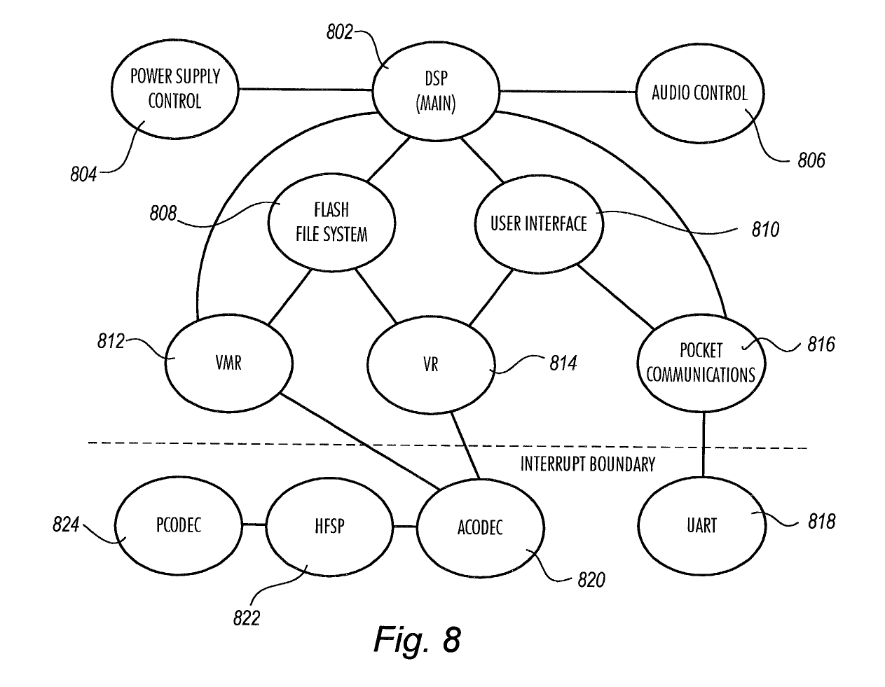

Referring now to FIG. 8, the architecture of the docking station 106 software showing the relationships among the various software objects, is illustrated. In general, the top level loop is the digital signal processor object 802. Thus, the power supply control 804, audio control 806, flash file system 808, user interface 810, voice memo recording 812, voice recognition 814, and pocket communications 816 objects can all be entered from the main loop 802 directly. Other software objects or modules are addressed in response to interrupts. Accordingly, communications between the pocket 104 and the docking station 106 generate an interrupt causing the software to enter the UART object 818. Activity concerning the near-end CODEC 334 is handled at object 820 across the interrupt boundary from the voice memo recording 812 and voice recognition 814 objects. Sound processing 822 and far-end CODEC 824 objects are associated with the near-end CODEC 820 object.

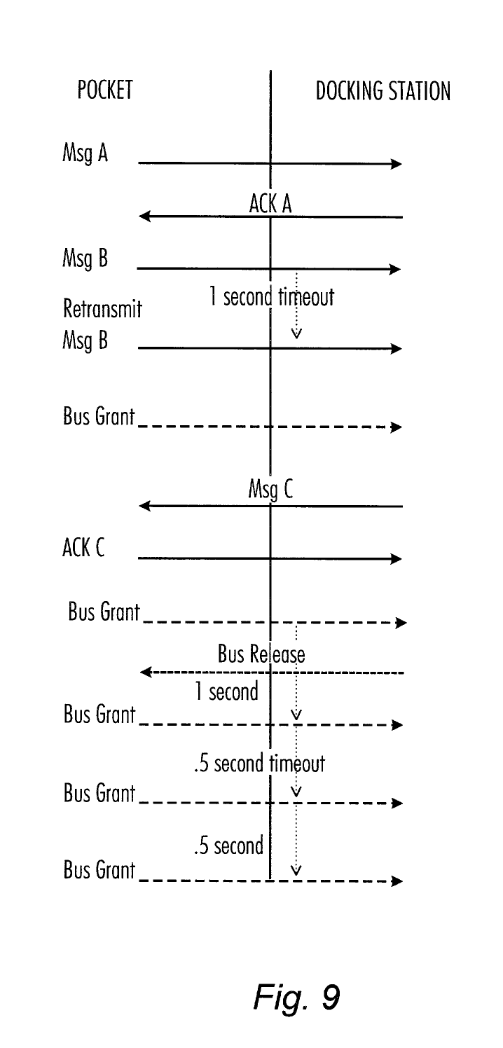

The progression of typical communications scenarios are illustrated in FIG. 9. In FIG. 9, message A is shown originating in the pocket 104. An acknowledgment of message A originates in the docking station 106, and is transmitted to the pocket 104. A second message, message B, originates at the pocket 104, and is passed to the docking station 106. After a one second time out, during which no message is received at the pocket 104, message B is retransmitted. Next in the diagram, the pocket 104 issues a bus grant message. In response to the bus grant, the docking station 106 issues a pending message, message C. In response to message C, the pocket 104 issues an acknowledgment. The pocket 104 next issues another bus grant. In response, the docking station issues a bus release message, as the docking station has no pending message. After one second, the pocket 104 again issues a bus grant message. Receiving no reply, after a 0.5 second time out, the pocket 104 issues a second bus grant message. Again receiving no reply, the pocket 104 issues yet an other bus grant message. The above-described typical scenarios serve as examples, and it will be appreciated that additional alternative scenarios are possible.

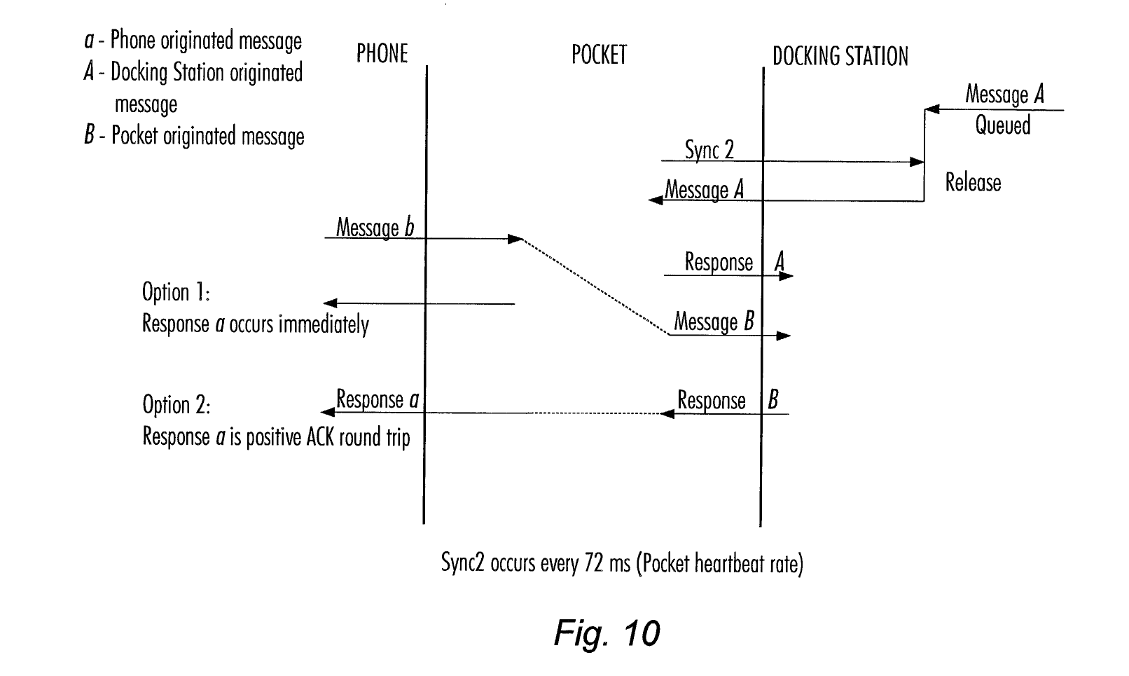

With reference now to FIG. 10, a pocket 104 worst case scenario is illustrated. In FIG. 10, message A, is shown queued in the docking station 106. Message A is released after synch 2 to the pocket 104. At the time Message A is released, Message b is received from the telephone 102. In response to this situation, the pocket can immediately pass Message A to the telephone and return Response A to the docking station, while delaying handling of Message B from the telephone, or the pocket can communication Message B to the docking station as Message B while delaying the handling of Message A.

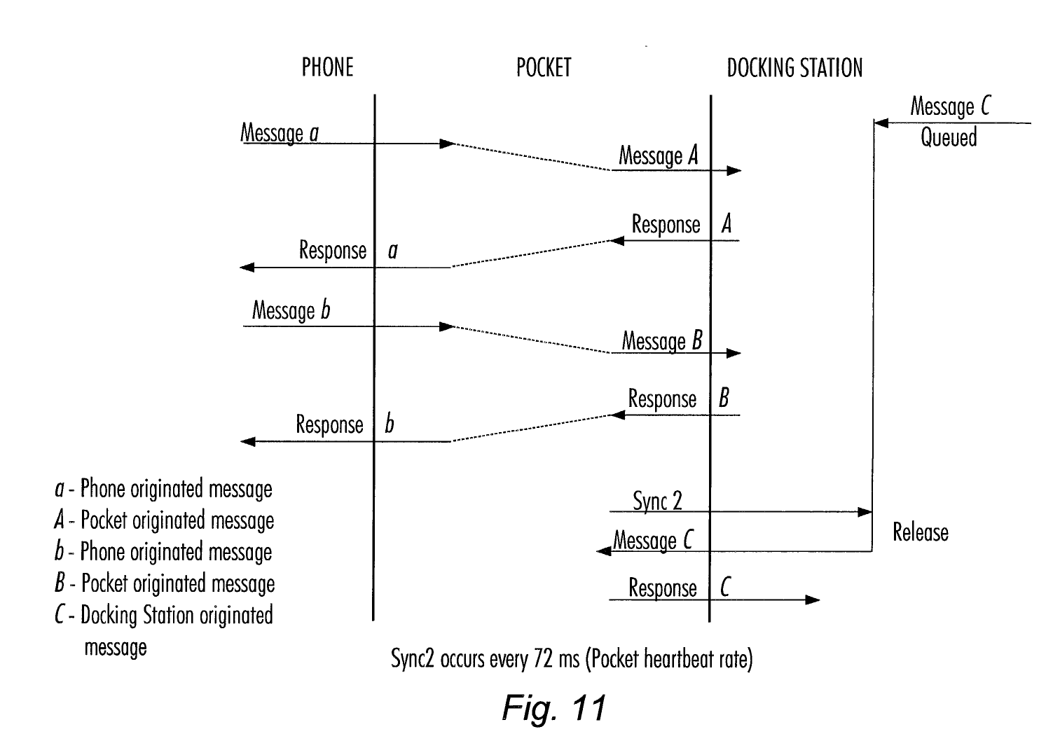

With reference now to FIG. 11, a docking station 106 worst case scenario is illustrated. In FIG. 11, Message C is shown queued in the docking station 106. Shortly after Message C is queued, Message a is received at the telephone 102 and is communicated through the pocket 104 and to the docking station 106 as Message A. Then while Message C continues to be queued, Response A is communicated to the telephone 102 as Response a. Message B is then received at the telephone 102 and is communicated to the docking station 106 through the pocket 104 as Message B. The docking station 106 then sends Response B through the pocket 104 into the telephone 102 as Response b. Following the receipt of Response b at the telephone 102, a synchronization signal, labeled Synch 2, is sent from the pocket 104 to the docking station 106, causing the release of the queued message. Message C is then delivered to the pocket 104, and Response C delivered from the pocket 104 to the docking station. Therefore, in this worst case scenario, Message C could not be handled until Messages A and B had been dealt with, and the synchronization signal received.

According to one embodiment of the system 100 of the present invention, the docking station 106 is provided with programming instructions necessary for communicating with the telephone 102. According to this embodiment, the pocket 104 need not be provided with a microprocessor 320 or memory 324. Instead, the pocket 104 may simply provide a physical interconnection to the telephone 102, and for the transfer of signals from the telephone 102 directly to the docking station 106. Where the docking station 106 is not intended to interconnect to telephones 102 having a variety of physical characteristics, the pocket 104 need not be a component that is separate and distinct from the docking station 106. According to one embodiment, the docking station 106 may be provided with programming code enabling it to interface with a variety of telephones 102. Thus, the pocket 104 may provide a signal to the docking station 106, for example, by providing differing voltage levels at input pins associated with the docking station 106 microprocessor 328 to indicate the type and capabilities of the telephone 102. The docking station 106 may use this information to select the appropriate command set for communicating with the telephone 102. The docking station 106 may be upgraded to provide advanced capabilities, or to communicate with additional telephones 102 through upgrades to the programming code generally stored in the docking station memory 340. The upgrades may be provided to the docking station 106 by interconnecting the docking station 106 to a personal computer that has read or downloaded the code upgrade, or by downloading the upgrade through an Internet-enabled telephone 102 directly to the docking station 106.

The text to speech functionality described above with respect to certain embodiments of the present invention may be augmented by the ability to visually display textual information. Accordingly, textual information may be displayed, for example, on a screen associated with an external subsystem 378. Thus, textual information may be displayed on the screen of a personal digital assistant (PDA), a personal computer, or a display screen provided by the automobile 302. The system 100, upon receipt of textual information, may in a default mode provide a visual output of text where a visual display is interconnected to the system, and an audible output. The user may also select whether textual information is to be provided audibly or visually. For example, a user may command the system 100 to “read e-mail.” Alternatively, the user may command the system 100 to “display e-mail.”

The system 100, particularly in connection with an automobile 302, may provide a variety of useful, automated functions. For example, the docking station 106 maybe provided with a custom interface 348 that includes a telematics module to monitor activity occurring on an external subsystem 378. For instance, where a first external subsystem 378 is a vehicle bus, a message indicating a low fuel status transmitted over the bus may be decoded by the custom interface 348. The custom interface 348 may then cause a query to be transmitted over the wireless link provided by the telephone 102 to a central station interconnected to the Internet. The query, which may be transmitted from the telephone 102 according to the Internet protocol, may request the location and prices of fuel available in the area. The response to the query may be provided to the user of the system 100 through a visual display provided as, for example, a second external subsystem 378, or may be provided audibly to the user through the text to speech capabilities of the system 100. According to one embodiment, the query includes information concerning the location of the automobile 302. Such information may be provided automatically, for example, from a GPS receiver interconnected to the system 100 as a third external subsystem 378. Alternatively, location information may be provided by a telephone 102 capable of receiving GPS data.

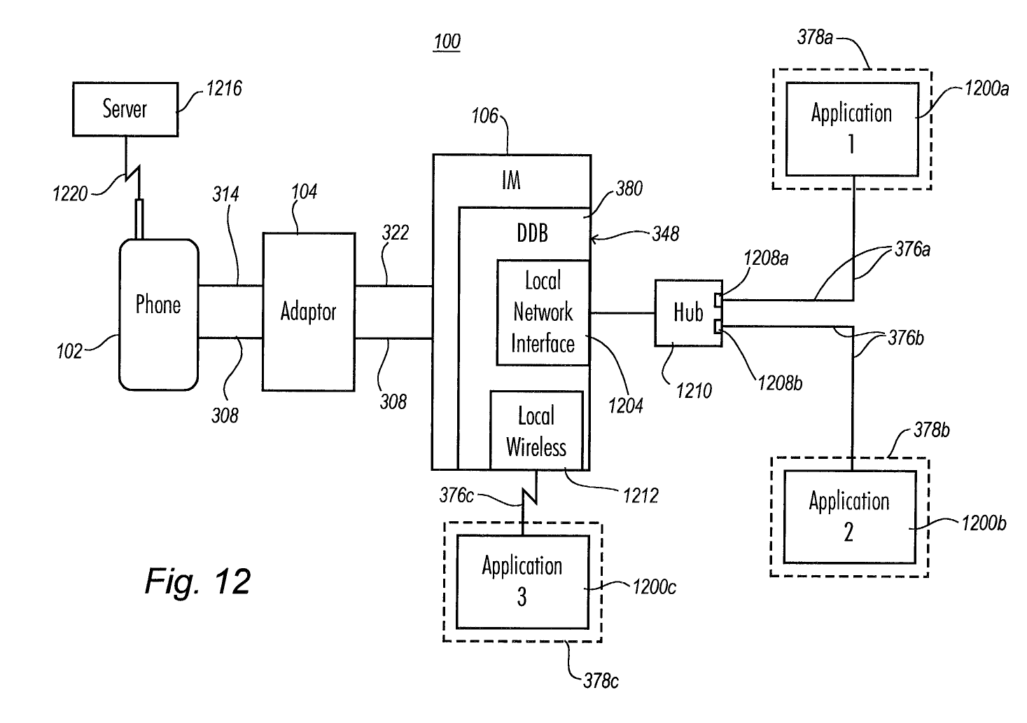

With reference now to FIG. 12, a system 100 in accordance with an embodiment of the present invention is illustrated. The system 100 shown in FIG. 12 interconnects a telephone 102 to a plurality of applications 1200a, 1200b, and 1200c running on external subsystems 378a, 378b and 378c. As shown in FIG. 12, the docking station 106 of the illustrated embodiment includes an interface or a custom interface 348, which may be included as part of a data daughter board (DDB) 380, for providing an interface between the docking station 106 and the external subsystems 378a-c. Although the following discussion will generally describe an interface 348 that is provided as part of a data daughter board 380, the interface 348 may be provided as part of the docking station 106 itself. For example, the interface 348 or any other interface, may be provided as part of a main circuit board of the docking station 106. Alternatively, at least some of the components or functions of the interface 348 may be provided as part of a cable interconnecting the external subsystem to the docking station 106.

The interface 348 may include a local network interface 1204 for providing ports 1208a-b via a network hub 1210 to interconnect subsystems 378a and 378b, and the associated applications 1200a and 1200b, to the docking station 106 over signal lines 376a and 376b. For example, the local network interface 1204 may comprise an interface for TCP/IP formatted data, such as an Ethernet network card. Although only two applications 1200a and 1200b are illustrated as being interconnected to the docking station 106 over signal lines 376a and 376b, it can be appreciated that the number of applications 1200 that can be so interconnected is limited only by the capacity of the local network. As will be understood by those of skill in the art, the hub 1210 may be integral to the interface 348, may be provided on a data daughter board or may be provided separately. Alternatively, the network interface 1204 may be used to interconnect the docking station 106 to an application 1200 without the use of a hub 1210. Therefore, the network interface 1204 may comprise a network hub alone or in combination with a network interface card. As will also be understood by those of skill in the art, more than one application 1200 may be running on a single external subsystem 378.

The interface 348 may, in addition or as an alternative to a local network interface 1204 for use with wired signal lines 376a and 376b, comprise a local wireless network interface 1212. In an embodiment in which a local wireless network interface 1212 is provided, a wireless line or lines of communication 376c serves to transmit information between the local wireless network interface 1212 and the application 1200c running on the external subsystem 378c. The local wireless network interface 1212 may be interconnected to the docking station 106 via a connection to a port on the network interface 1204 or the hub 1210. Alternatively, the wireless interface 1212 may be directly interconnected to the docking station 106. Although only one application 1200c is shown in communication with the docking station 106 over the wireless signal line 376c, it can be appreciated that the number of applications so interconnected depends only on the capacity of the local wireless network. Furthermore, it will be appreciated that more than one application 1200 may be running on a single external subsystem 378 interconnected to the docking station by the wireless signal line 376c.

In general, the interface or interfaces 348 provided by the docking station 106 allow information to be passed between the docking station 106 and the interconnected external subsystems 378 as digital packet data. For instance, data may be passed between the interface 348 and the external subsystems 378 as packets of data formatted according to a data transmission protocol, such as the TCP/IP protocol. By providing a standard interface (i.e. the interface 348), the data daughter board 380 allows the docking station 106 to interface with any application 1200 running on an external subsystem 378 that is capable of communicating over a network using such a data transmission protocol. Therefore, the applications 1200 may include applications running on an external subsystem 378 comprising a computer equipped with a network interface that is compatible with the interface 348. Suitable computers include laptop and notebook computers. In addition, an application 1200 may be executed on a personal digital assistant (PDA) or other device having an appropriate network connection. In general, any external subsystem 378 and associated application or applications 1200 capable of communicating with the provided interface 348 may be interconnected to the docking station 106 by the data daughter board 380. Accordingly, it can be appreciated that the interface 348 of the docking station 106 provides a physical communications layer between the external subsystem 378 and the docking station 106. The docking station 106, in cooperation with the adaptor 104, also provides translation between the control commands used for communication between an application 1200 and the docking station 106, and the command set needed to operate the telephone 102. Accordingly, it should be appreciated that due to the physical and logical interface provided by the docking station 106 and the adaptor 104, neither the external subsystem 378 nor the application 1200 is required to provide the particular physical and logical interface required by the particular telephone 102 used to establish a communications channel 1220.

Communications received from the applications 1200 are passed from the docking station 106 to the adaptor 104 by either the digital data path signal lines 308 or the pocket-docking station bus 322. Communications passed over the pockcet-docking station bus 322 generally comprise wireless communications device control commands, as will be described in greater detail below. Data passed along the digital data path signal lines 308 generally includes data for transmission by the telephone 102. Accordingly, data passed along the digital data path 308 is, according to one embodiment of the present invention, not altered by the adaptor 104 before it is transmitted to a base station or server 1216 by the telephone 102 across wireless communications channel 1220. According to another embodiment of the present invention, the data passed along the digital data path 308 is reformatted, such as from a serial bit stream format used along signal lines 376 to a parallel bit format used by the telephone 102. The reformatting of the data, where necessary, may be performed by the adaptor 104. Communications passed across the pocket-docking station bus 322 are generally translated by the adaptor 104 into the format required by the telephone 102 before being passed to the telephone 102 over the telephone control signal bus 314. For instance, communications channel control commands passed from an application 1200 to the docking station 106 will, according to one embodiment of the present invention, be translated into at least a first command selected from a set of system commands according to the API of the system 100 by the docking station 106, and these in turn will be translated by the adaptor 104 into corresponding wireless communications device control commands that can be understood by the telephone 102.

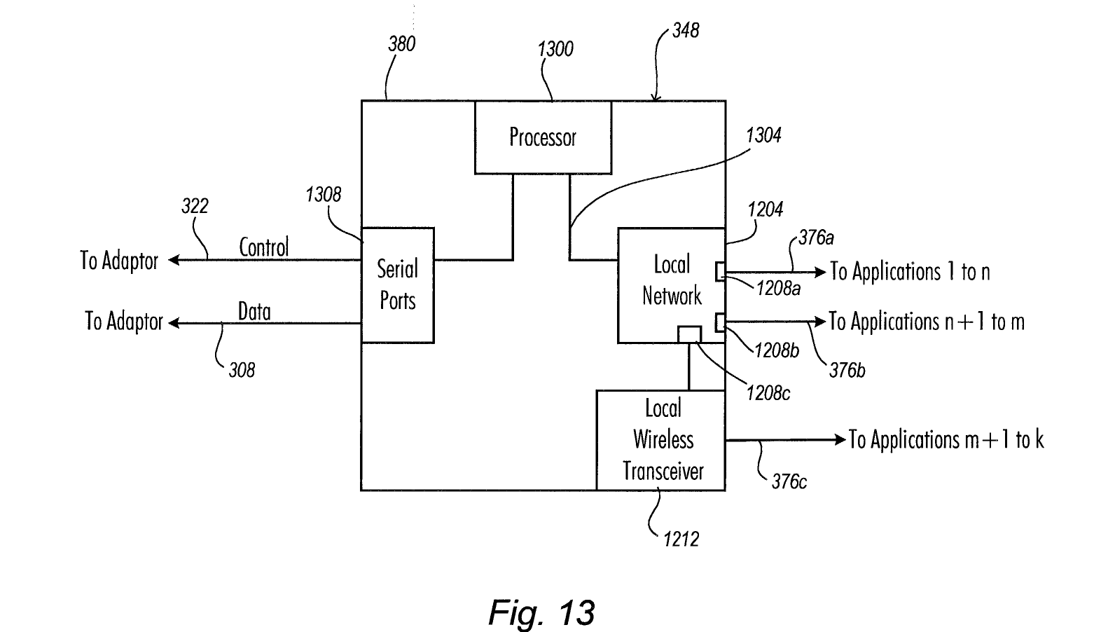

With reference now to FIG. 13, details of a data daughter board 380 comprising the interface 348 in accordance with an embodiment of the present invention are illustrated. As seen in FIG. 13, the local network interface 1204 is interconnected to a processor 1300 by an internal bus 1304. In the embodiment illustrated in FIG. 13, a local wireless network interface 1212 is interconnected to the processor 1300 via the local network interface 1204 and internal bus 1304. Accordingly, in this embodiment of the data daughter board 380, the local wireless interface 1212 acts as a device or network gateway interconnected to the local network interface 1204.

The processor 1300 may include a microprocessor or a digital signal processor. In general, the processor 1300 examines data packets received from the local network interface 1204 to determine whether they contain control commands directed to the operation of the telephone 102, or data for transmission across the wireless communications channel 1220. According to one embodiment of the present invention, control commands have a unique address to indicate to the processor 1300 that a communications channel control command is contained in the packet of data. For instance, control commands may be addressed to a virtual control data port established by the interface 348. Communications channel control commands are translated by the processor 1300 into system API commands and are provided to the adaptor 104 over the pocket-docking station bus 322 by serial ports 1308, while data received from the applications 1200 for transmission is placed on the digital data signal lines 308 by the serial ports 1308. Where the telephone 102 supports, for example, an Internet Protocol (IP) data stream, the data for transmission may simply be passed between the network comprised of the telephone 102, data signal lines 308, channel 1220 and server 1216, and the local network that includes the application 1200, and the signal lines 376 by the interface 348. According to an embodiment of the present invention, the applications 1200 are configured to point to the interface 348 as their gateway. According to a further embodiment of the present invention, packets of data for transmission are addressed to a virtual data transmission data port and are thus recognized by the interface 348 as containing data for transmission over the wireless communications channel 1220.

According to an embodiment of the present invention, a telephone 102 that does not provide IP framed data may be used in connection with applications 1200 that communicate using a TCP/IP protocol. For instance, the telephone 102 may be capable of sending and receiving data using a wireless application protocol (WAP) or other protocol. Such a telephone 102 may be capable of accessing certain web pages on the Internet that are formatted so that the information contained on the pages can be displayed by the display 114 of the telephone 102. Furthermore, the displayed information may not be available as IP data from the electrical connector 116 provided on the telephone 102.

However, signals representing the characters displayed by the telephone 102 may be available. In such instances, the interface 348 may packetize the raw data regarding the displayed characters and provide that raw data to an application 1200. The reverse of this operation may also be performed to send information from an application to a server 1216. Accordingly, the interface 348 may present a TCP/IP interface to an application 1200 even when the system 100 is used in connection with telephones 102 that provide a nonstandard data stream.

With reference now to FIGS. 3, 12 and 13, communications channel control commands may be passed between an application 1200 running on an external subsystem 378 and the local network interface 1204 over the signal line 376 as TCP/IP type packet data. Furthermore, the commands are selected from a set of standardized control commands. According to an embodiment of the present invention, these standardized control commands are in the form of textual messages. The interface 348, and in particular the processor 1300, may be used to translate between the standardized control commands and the API of the system 100, if they are different. The commands, formatted according to the API of the system are passed between the docking station 106 to the microprocessor 320 of the adaptor 104 by the pocket-docking station bus 322. As will be described in greater detail below, the microprocessor 320 reformats the API command as required. In particular, the microprocessor 320 translates the commands between the API of the system and the set of commands used by the telephone 102.

For example, the interface 348 may receive a command selected from a set of standardized communications channel control commands. The processor 1300 may then translate that command into a command or commands selected from a set of API control commands and formatted according to the API of the system. The command is then passed to the microprocessor 320, which translates the command that has been formatted according to the API of the system 100 into a corresponding wireless communications device control command selected from the set of wireless communication device control commands used by the telephone 102. In this way, the adaptor 104 and docking station 106 allow communications channel control commands formatted according to a general standard, such as one that allows an application 1200 to issue commands in the form of textual messages, to be reformatted so that they can be acted upon by a particular telephone 102. Therefore, the translation function provided by the adaptor 104 removes the need for the applications 1200 to issue commands using the command set of the telephone 102 in order to control the operation of the telephone 102.

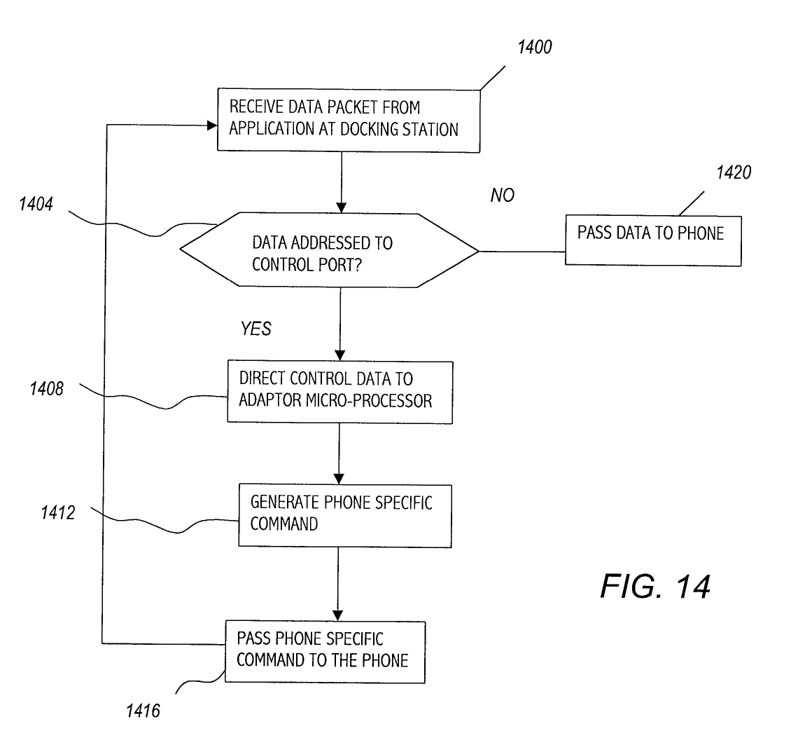

With reference now to FIG. 14, the operation of a system 100 in accordance with an embodiment of the present invention is illustrated. In particular, FIG. 14 illustrates the operation of an embodiment of the system 100 in connection with the receipt of data from an application 1200.

Initially, at step 1400, a data packet is received from an application 1200 at the docking station 106. In particular, the data packet is received by the local network interface 1204 and passed to the processor 1300. The processor 1300 determines whether the received data packet is addressed to the virtual control data port or whether it contains data for transmission (step 1404). If the data packet contains a communications channel control command, it is addressed to the logical or virtual control data port, formatted according to the API of the system by the interface 348 and directed to the microprocessor 320 of the adaptor 104 over the pocket-docking station control bus 322 (step 1408). The microprocessor 320 receives the control command and generates a wireless communications device control command that is formatted according to the requirements of the telephone 102 (step 1412). The telephone-specific command is then passed to the telephone 102 over the telephone control signal bus 314 (step 1416).

If the data packet contains data for transmission, and if the telephone 102 can send and receive TCP/IP formatted data, the data is bridged from the local network that includes the application 1200 to the network that includes the telephone 102, wireless communications channel 1220, and server 1216 by the interface 348. In crossing the interface, header information regarding the addressing of the data packets may be altered, but otherwise the data is passed to the telephone 102 directly. That is, the payload of the data packets remains unaltered by the interface 348. The data for transmission is then communicated between the interface 348 and the telephone 102 by the digital data path signal lines 308. Accordingly, in connection with data for transmission, the function of the adaptor 104 is to provide a physical interconnection between the telephone 102 and the digital data path signal lines 308. According to a further embodiment of the present invention, the data for transmission may be reformatted as a parallel bit stream before it is passed to the telephone 102, for those telephones 102 that provide and receive a parallel bit stream at the electrical connector 116. According to still another embodiment of the present invention, the data packets containing data for transmission are formatted as PPP or SLIP data packets.

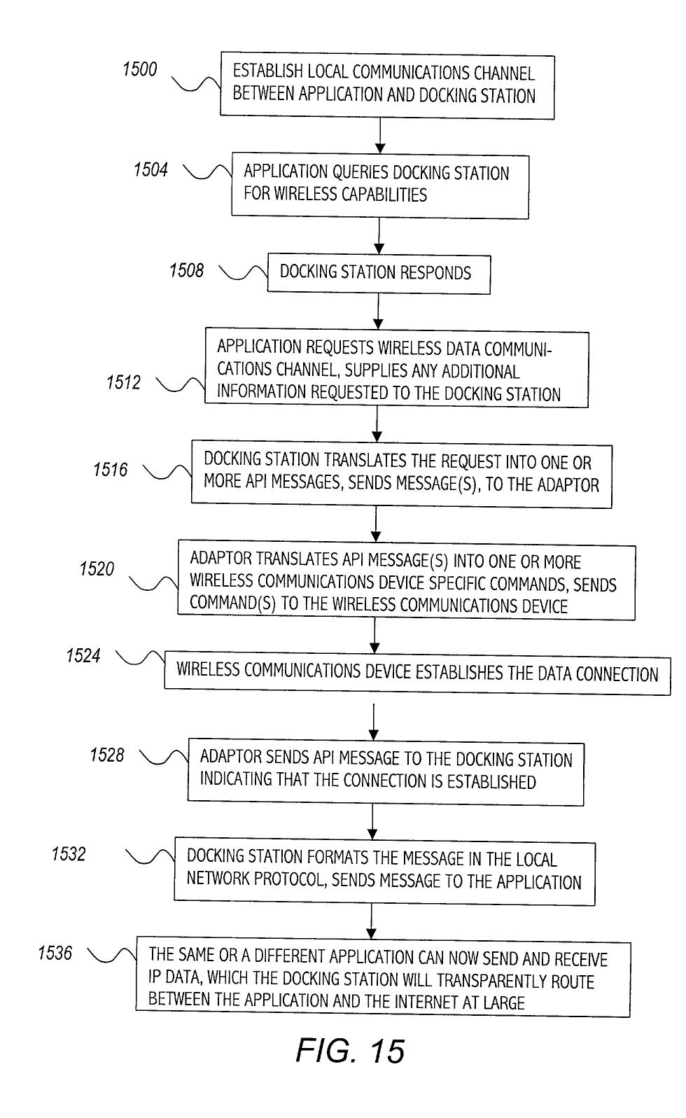

With reference now to FIG. 15, the operation of a system 100 in accordance with an embodiment of the present invention in response to a request by an application 1200 for a communications channel 1220 is illustrated. Initially, at step 1500, a local communications channel is established between the application 1200 and the docking station 106. For example, the user of a laptop computer may establish a signal line 376a by using a cable to interconnect the docking station 106 and the laptop computer 378, thereby providing a physical channel for data to be passed between the application 1200 and the docking station 106. Next, the application 1200 queries the interface 348 of the docking station 106 for information regarding the capabilities of the telephone 102 (step 1504). It should be appreciated that the application 1200 used to request a communications channel 1220 may be specifically adapted to that purpose. Alternatively, a larger, general purpose application 1200, such as a web browser or an e-mail application may be provided with the functionality required to request a communications channel 1220, for example through a plug-in. As a further alternative, the user may enter commands in a communication program, such as Telnet, available from Microsoft® Corporation, to request a communications channel. The docking station 106 then responds (step 1508). The docking station 106 generally can respond to the query because it is provided with information regarding the telephone's capabilities from the adaptor 104.

In particular, the adaptor 104 may be encoded with information regarding the telephone's capabilities, such as where the adaptor is configured for use with one or more telephones 102 having a common feature set. Alternatively, the telephone 102 may automatically provide identification information or information regarding its capabilities when it is placed in the adaptor 104. The adaptor 104 may use this information to determine the set of wireless communications device control commands that must be used in order to interact with the telephone 102, and to determine the capabilities of the telephone 102. If the adaptor 104 is programed with information regarding the telephone 102 capabilities, or is provided with that information from the telephone 102 itself, queries concerning such information can be responded to by the docking station 106 using the information provided by the adaptor 104, without passing the query on to the telephone 102. Alternatively, if the docking station 106 cannot answer the query based on the information provided by the adaptor 104, the query may be passed to the telephone 102 itself. The capabilities of the telephone 102 are returned to the application 1200 through the interface 348. The capabilities of the telephone 102 determine, for example, whether the application 1200 is required to provide a telephone number to the telephone 102 in order for a wireless communications channel 1220 to be established. In addition, the interface 348 must know how data for transmission by the phone should be formatted. For example, whether data should be sent as TCP/IP formatted data or formatted according to another protocol, such as PPP, SLIP, etc.

At step 1512, the application 1200 requests a wireless data communications channel, and supplies any additional information required by the telephone 102 to the docking station 106. Accordingly, the request may include providing the telephone 102 with a telephone number, a password, or simply commanding the telephone 102 to establish the wireless communications channel 1220. The request may be issued by the application 1200 using a command selected from the set of textual messages that comprises the standardized command set used to communicate communications channel control commands between the application 1200 and the interface 348. Because the data packet or packets used to communicate the request contain a communications channel control command, it will be addressed to the data control port of the data daughter board 380. The docking station 106 recognizes that the data packet contains a communications channel control command because it is addressed to the control data port of the interface 348. Accordingly, the docking station 106 translates the request into one or more messages according to the API of the system and passes the command to the adaptor 104 over the pocket-docking station communications bus 322 (step 1516).

The adaptor 104 receives the request formatted according to the system protocol (e.g., the API of the system 100), translates the request into one or more wireless communications device specific commands and passes the commands to the telephone 102 (step 1520). For example, the command to access or establish a communications channel 1220 may include a command to dial a number specified by the application 1200, the adaptor 104, or the docking station 106. In response to such a command, the adaptor 104 must provide the telephone 102 with electrical signals at the correct pins of the electrical connector 116 and in the correct sequence in order to simulate entry of the number using the keypad 112 of the telephone 102. The reformatted request is provided to the telephone 102 over the telephone control signal bus 314. Accordingly, the adaptor 104 provides the request using commands selected from the set of wireless communications device control commands understood by the telephone 102 and in the format required by the telephone 102, in addition to providing the electrical connector required to deliver the request to the telephone 102.

The telephone 102, in response to the request, establishes a communications channel 1220 with the base station or server 1216 (step 1524). How the telephone 102 establishes the communications channel 1220 depends on the particular telephone 102. For example, a telephone 102 having a dedicated data transmission channel may simply perform the steps necessary to activate that channel. Alternatively, the telephone 102 may be directed to a server or base station 1216 specified by the application 1200. For example, the request to establish a communications channel 1220 may include a direction to the telephone 102 to dial a specified telephone number and ready itself for data transmission. It should be appreciated that the request to establish a communications channel 1220 may be communicated by providing the telephone 102 with a series of commands. For example, the telephone 102 may be provided with each digit of a telephone number serially, followed by a command to dial.

As a further example, the command from the application 1200 to access or establish a communications channel 1220 may contain no specific information regarding the gateway or server 1216 with which the channel 1220 is to be established. In such instances, the adaptor 104 or the docking station 106 may provide a previously stored telephone number to be dialed. If the telephone 102 is capable of establishing a communication channel 1220 for transmitting data without using a dial up connection, the command that is provided to the telephone 102 need only comprise an instruction to establish the communications channel 1220. If a request for a communications channel 1220 is received from a second application 1200b after the communication channel 1220 has already been established by, for example, a first application 1200a, the request does not need to be provided to the telephone 102. Instead, the docking station 106 may recognize that a channel 1220 has already been established and may provide a signal to the application 1200b indicating that the channel 1220 is available.

In general, the telephone 102 will provide a signal indicating that the communications channel 1220 has been established and is ready to transmit data. The telephone 102 issues this signal using the protocol determined by the manufacturer of the particular telephone 102 (i.e. using a wireless communications device control command). Accordingly, the confirmation of channel availability may be provided as a serial or parallel bit stream that encodes information regarding the available channel 1220. Alternatively, the availability of a channel 1220 may be signaled by changing the voltage at a single contact of the electrical connector 116. Regardless of how the telephone 102 signals the availability of the channel 1220, the signal is received by the adaptor 104 and is translated and reformatted to comply with the API of the system 100. The translated and reformatted signal is then passed to the docking station 106 (step 1528). The docking station 106, according to the present example, translates the API message into a textual message according to the set of wireless communications channel control commands, formats it as a TCP/IP data packet and passes it to the application 1200 (step 1532).

After the availability of the channel has been communicated to the application 1200, data may be sent and received from the application 1200 used to establish the wireless communications channel 1220 (step 1536). Alternatively, the application 1200 used to establish the wireless communications channel 1220 may exit, and any Internet aware application 1200 may communicate over the wireless communications channel 1220 in a normal fashion. The data that is passed between the server 1216 and the application 1200 is generally not reformatted by the adaptor 104. Instead, the data for transmission, which is formatted according to a universal protocol, such as TCP/IP, is supplied directly to the telephone 102 from the application 1200 as a serial bit stream. However, when required by the telephone 102, the serial TCP/IP data stream from the application 1200 is reformatted. For instance, the data may be presented to the telephone 102 as a parallel bit stream, or reformatted according to the PPP, SLIP or some other protocol.

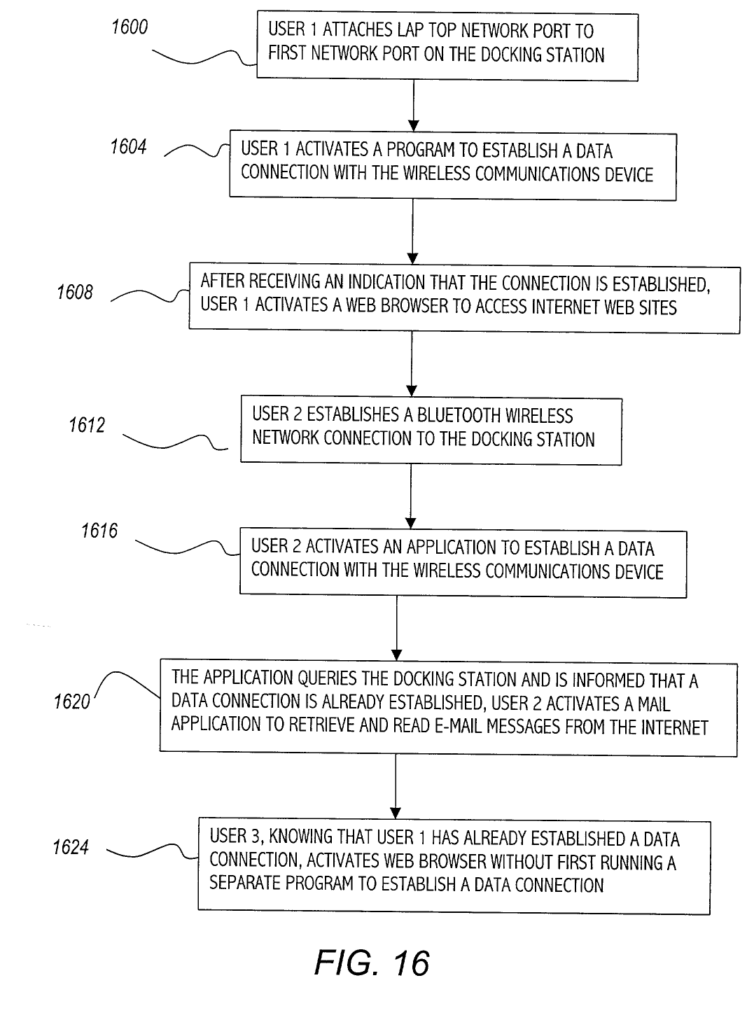

With reference now to FIG. 16, the operation of a system 100 in accordance with an embodiment of the present invention is illustrated in the context of an example. For purposes of this example, it will be assumed that the system 100 is installed in an automobile 302. According to this example, the external subsystem 378a is a first laptop computer, external subsystem 378b is a second laptop computer, external subsystem 378c is a PDA, application 1 1200a initially represents an application used to establish a wireless communication channel 1220 and later represents a standard web browser, as explained below. Application 1200c initially represents an application used to establish a wireless communications channel 1220, and later represents a standard e-mail program, as explained below. Initially, at step 1600, user 1 attaches her laptop computer 378a to a local network interface 1204 port 1208a provided on the docking station 106 using a cable, thereby establishing a signal line 376a. For purposes of the present example, the local network interface 1204 can be assumed to include an Ethernet network card, and it will be assumed that the laptop computer 378a is also equipped with an Ethernet network card. The cable 376a connecting the Ethernet port of the hub 1210 to the Ethernet port of the laptop computer 378a is an Ethernet cable having connectors for interfacing with mating connectors on the network cards and/or hub.

After completing the hardware connection with the docking station 106, user 1 activates an application 1200a on her laptop computer 378a to establish a data connection with the telephone 102 (step 1604), as described above in connection with steps 1504-1524 of FIG. 15.

After receiving an indication that the telephone 102 has established a wireless communications channel 1220, the initial application 1200a used to establish the wireless communications channel 1220 exits, and user 1 activates a web browser 1200a to access Internet web sites in a normal fashion (step 1608).

At step 1612, user 2 establishes a Bluetooth wireless network connection between a PDA 378c and the docking station 106. User 2 then activates an application 1200c to establish a data connection with the telephone 102 (step 1616). The application 1200c queries the docking station 106, and is informed that a data connection is already established. The application 1200c used to establish the data connection then exits, and user 2 activates a mail application 1200c to retrieve and read e-mail messages from the Internet (step 1620).

User 3 then interconnects a second laptop 378b to a second network port 1208b on the docking station 106. User 3, knowing that user 1 has already established a data connection, activates a web browser 1200b on a second laptop 378b without first running a separate application to establish a data connection (step 1624). Accordingly, it can be appreciated that the docking station 106 functions as an Internet gateway to any Internet aware application 1200 that is in communication with the docking station 106.

From the above example, it can also be appreciated that multiple devices may share a communications channel 1220 established by the system 100. In particular, data packets addressed to different devices and servers may be transmitted across the communications channel 1220 at substantially the same time.

Although the examples set forth above are in the context of communications initiated by external devices 378, it should be appreciated that communications can also be initiated by devices or applications that are at the server 1216 side of the channel 1220. In such instances, data addressed to a particular device 378 or application may be routed from the telephone 102 to the receiving device 378 or application 1200. Of course, any required translation of the data format, such as from a parallel bit stream to a serial bit stream, may be performed in the adaptor 104.

Although the examples described above involve a system API having a format and command set that are different from those of the wireless communications channel control commands, this is not necessarily the case. For instance, according to one embodiment of the present invention, the API used to communicate control commands between the interface 348 and the adaptor 104 may include as valid commands the set of textual messages included as part of the set of wireless communication channel control commands. According to such an embodiment of the present invention, no translation of commands must be performed by the interface 348, although reformatting of the command data may still be required.

In accordance with the present invention, a method and apparatus for wireless communications are provided. The invention in its broader aspects relates to an economical method and apparatus for providing various levels of hands-free functionality in combination with wireless communications devices. In particular, the present invention provides a method and apparatus allowing for a wide variety of telephones and pockets to be used with a common docking station, and in connection with multiple external devices.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include alternative embodiments to the extent permitted by the prior art.

What is claimed is:

1. A method of providing a wireless communications channel, comprising:
receiving at a docking station a first signal comprising at least a first communications channel control command from a first application program, wherein said first signal is formatted according to a first protocol, and wherein said docking station comprises an adaptor;
in response to receiving said first signal, selecting at least a first wireless communications device control command and formatting said at least a first wireless communications device control command according to a second protocol to create a second signal; and
passing data received from at least one of said first application program and a second application program through said adaptor and to a wireless communications device, wherein said data is transmitted over said communications channel.

2. The method of claim 1, wherein said at least a first communications channel control command corresponds to said at least a first communications device control command.

3. The method of claim 1, wherein said transmitted data is formatted according to said first protocol.

4. The method of claim 1, wherein said transmitted data is formatted according to a third protocol.

5. The method of claim 1, wherein said data received from said at least one of said first application program and said second application program is a serial data stream, and wherein said step of passing said data received from said at least one of said first application program and said second application program to said wireless communications device comprises encoding at least a portion of said serial data stream as a parallel data stream.

6. The method of claim 1, wherein said at least a first wireless communications device control command is selected from a set of wireless communications device control commands, and wherein said first set of wireless communication device control commands is determined by said wireless communications device.

7. The method of claim 1, wherein said at least a first wireless communications device control command is selected from a first set of wireless communications device control commands, and wherein said adaptor is incapable of selecting and formatting a wireless communications device control command selected from at least a second set of wireless communications device control commands.

8. The method of claim 1, further comprising:
receiving at said adaptor a third signal comprising at least a second communications device control command from said wireless communications device, wherein said second communications device control command is formatted according to said second protocol; and
selecting at least a first communications channel control command and formatting said at least a first communications channel control command according to said first protocol to create a fourth signal, wherein said steps of selecting and formatting are performed by said adaptor.

9. The method of claim 1, wherein said first wireless communications channel control command is selected from a first set of wireless communication channel control commands and is formatted according to said first protocol, wherein said first set of wireless communications channel control commands and said first protocol are determined by said docking station, wherein said at least a first wireless communications device control command is selected from a first set of wireless communications device control commands and is formatted according to said second protocol, and wherein said first set of wireless communications device control commands and said second protocol are determined by said wireless communications device.

10. The method of claim 1, wherein said step of selecting at least a first wireless communications device control command and formatting said at least a first wireless communications device control command according to a second protocol to create a second signal comprises:
selecting at least a first command from a set of API commands corresponding to said first signal;
formatting said selected at least a first API command;
selecting at least a first wireless communications device control command corresponding to said at least a first API command; and
formatting said at least a first wireless communications device control command.

11. The method of claim 10, wherein said steps of selecting and formatting an API command are performed by said docking station, and wherein said steps of selecting and formatting at least a first wireless communications device control command are performed by said adaptor.

12. The method of claim 1, further comprising:
receiving at said docking station a query for information regarding capabilities of said wireless communications device from said at least one of said first application program and said second application program, and returning said information to said at least one of said first application program and said second application program.

13. The method of claim 12, wherein said information is stored in said docking station.

14. The method of claim 13, further comprising interconnecting said wireless communications device to said docking station, wherein said information is stored in said docking station when said wireless communications device is interconnected to said docking station.

15. An apparatus for providing a wireless communications channel to at least a first application, comprising:
an adaptor for interconnecting to a wireless communications device capable of transmitting data, wherein aspects of the operation of said wireless communications device may be controlled using wireless communications device control commands selected from at least a first set of wireless communications device control commands;
a docking station interconnected to said application and to said adaptor, wherein a command selected from at least a first set of communications channel control commands received from said at least a first application is translated into at least a first wireless communications device control command selected from said at least a first set of wireless communications device control commands, and wherein data other than data comprising control commands received from said application is not translated.

16. The apparatus of claim 15, wherein said data is formatted according to a first protocol, at least when it is passed between said at least a first application and said docking station.

17. The apparatus of claim 16, wherein said first protocol is an Internet protocol.

18. The apparatus of claim 15, wherein data other than data comprising control commands is formatted according to a first protocol when it is passed between said adaptor and said at least a first application, and wherein said data is formatted according to a second protocol when it is passed between said adaptor and said wireless communications device.

19. The apparatus of claim 15, wherein said docking station is interconnected to said at least a first application using a communications interface.

20. The apparatus of claim 19, wherein said communications interface comprises a daughter board.

21. The apparatus of claim 19, wherein said communications interface comprises an Ethernet interface.

22. The apparatus of claim 15, wherein said adaptor is of a first type when said wireless communications device requires a command selected from said first set of wireless communications device control commands, and wherein said adaptor is of a second type when said wireless communications device requires a command selected from a second set of wireless communications device control commands.

23. The apparatus of claim 15, wherein said docking station translates said command selected from at least a first set of communications channel control commands into a corresponding at least a first system command selected from a first set of system commands, and wherein said adaptor translates said at least a first system command into said at least a first wireless communications device control command selected from at least a first set of wireless communications device control commands.

24. The apparatus of claim 15, wherein said adaptor comprises memory and wherein said memory contains information regarding capabilities of said wireless communications device.

25. A method for providing a universal wireless data interface, comprising:
providing a docking station comprising an adaptor and at least a first standardized interface;
interconnecting said adaptor to a wireless communications device;
interconnecting at least a first external device to said standardized interface;
receiving at least a first communications channel control command from a first application running on said at least a first external device at said interface;
translating said at least a first communications channel control command into at least a first corresponding wireless communications device control command selected from a group of wireless communications device control commands; and
providing said at least a first wireless communications device control command to said wireless communications device.

26. The method of claim 25, further comprising:
interconnecting at least a second external device to said standardized interface;
receiving at least a second communications channel control command from a second application running on said second external device at said interface;
in said adaptor, translating said at least a second communications channel control command into at least a second corresponding wireless communications device control command selected from a group of wireless communications device control commands; and
providing said at least a second wireless communications device control command to said wireless communications device.

27. The method of claim 25, further comprising receiving at least a first data packet containing data other than a communications channel control command from at least one of said first application and a second application at said standardized interface;
providing said data packet to said wireless communications device, wherein said at least a first data packet is not reformatted by said adaptor.

28. The method of claim 25, wherein said interface translates said at least a first communications channel control command into at least a first system command selected from a set of system commands, and wherein said adaptor translates said at least a first system command into said at least a first wireless communications device control command.

29. A method for providing a wireless data interface, comprising:
providing a docking station comprising an adaptor and at least a first standardized interface, wherein said adaptor is capable of receiving a wireless communications device,
providing said adaptor with information regarding capabilities of said wireless communications device;
interconnecting at least a first external device to said standardized interface;
querying said adaptor for said information regarding capabilities of said wireless communications device; and
passing said information regarding capabilities of said wireless communications device to said external device.

30. The method of claim 29, wherein said step of providing said adaptor with information regarding capabilities of said wireless communications device comprises storing said information in said adaptor.

31. The method of claim 29, wherein said step of providing said adaptor with information regarding capabilities of said wireless communications device comprises receiving said information from said wireless communications device and storing said information in said adaptor.

32. The method of claim 31, further comprising placing a wireless communications device in said adaptor, wherein said information is received from said wireless communications device when said wireless communications device is placed in said adaptor.

33. The method of claim 29, wherein said step of providing said adaptor with information regarding capabilities of said wireless communications device comprises querying said wireless communications device for said information and passing said information from said wireless communications device to said adaptor.

34. The method of claim 29, further comprising:
receiving at least a first communications channel control command from an application running on said at least a first external device at said interface;
translating said at least a first communications channel control command into at least a first corresponding wireless communications channel control command selected from a group of wireless communications channel control commands; and
providing said at least a first wireless communications device control command to said wireless communications device.

35. An apparatus for providing a wireless communications channel to at least a first application, comprising:
an adaptor for interconnecting to a wireless communications device capable of transmitting data, wherein said adaptor is provided with information regarding capabilities of said wireless communications device;
a docking station interconnected to said at least a first application and to said adaptor, wherein said information regarding capabilities of said wireless communications device is provided to said at least a first application by said adaptor.

36. The apparatus of claim 35, wherein said information regarding capabilities of said wireless communications device is provided to said at least a first application by said adaptor in response to a query for said information by said at least a first application.

37. The apparatus of claim 35, wherein said information regarding capabilities of said wireless communications device is provided to said adaptor by storing said information in memory provided as part of said adaptor.

38. The apparatus of claim 35, wherein said information regarding capabilities of said wireless communications device is provided to said adaptor when said wireless communications device is interconnected to said adaptor.
